(19) United States
(12) Patent Application Publication
(10) Pub. No.: US 2023/0291024 A1
(43) Pub. Date: Sep. 14, 2023

(54) POWER FEEDING SYSTEM

(71) Applicant: IHI Corporation, Tokyo (JP)

(72) Inventor: Motonao NIIZUMA, Tokyo (JP)

(73) Assignee: IHI Corporation, Tokyo (JP)

(21) Appl. No.: 18/111,112

(22) Filed: Feb. 17, 2023

(30) Foreign Application Priority Data
Mar. 8, 2022 (JP) 2022-035002

(51) Int. Cl. H01M 10/615; H01M 10/625; H01M 10/63

(52) U.S. Cl. CPC H01M 10/615; H01M 10/625; H01M 10/63; H01M 2220/20

(57) ABSTRACT

A power feeding system feeds power to a vehicle equipped with a battery. The power feeding system includes: an accommodation portion including a heat insulating material and configured to accommodate the vehicle; a power feeding unit configured to feed power to the battery of the vehicle accommodated in the accommodation portion; a power feeding controller configured to control the power feeding to the battery by the power feeding unit; and a temperature sensor configured to detect temperature inside the accommodation portion. The power feeding controller is configured to control the power feeding to the battery such that the temperature detected by the temperature sensor is within a temperature range suitable for keeping the battery warm.

### CROSS-REFERENCE TO RELATED APPLICATIONS

This application claims the benefit of priority from Japanese Patent Application No. 2022-035002, filed on Mar. 8, 2022, the entire contents of which are incorporated herein by reference.

### TECHNICAL FIELD

The present disclosure relates to a power feeding system.

### BACKGROUND

The building structure that is described in Japanese Unexamined Patent Publication No. 2011-038365 is known as an example of a technique related to a power feeding system feeding power to a vehicle. In this building structure, an air conditioner supplies cold or warm air to the vehicle in the process of charging. The techniques that are described in Japanese Unexamined Patent Publication No. 2004-327223 and Japanese Unexamined Patent Publication No. 2010-192409 are known as examples of a technique focusing on a battery mounted in such vehicles. Japanese Unexamined Patent Publication No. 2004-327223 discloses an openable and closable battery storage device that is mounted in a vehicle and stores a battery in the vehicle. Japanese Unexamined Patent Publication No. 2010-192409 discloses a battery storage that is installed in an underfloor space of a building and stores a battery.

### SUMMARY

In a power feeding system as described above, power is fed to, for example, a vehicle such as an electric car parked in a parking facility. Usually, a parked vehicle is in a state where an electrical device such as heater does not operate, and thus the temperature of the vehicle may substantially vary with a change in ambient environmental temperature. The performance of a battery mounted in the vehicle may be substantially affected by such a change in temperature. Therefore, from the viewpoint of maintaining the performance of the battery, it is important to keep the battery warm appropriately. Meanwhile, as for the techniques that are described in, for example, Japanese Unexamined Patent Publication No. 2011-038365, Japanese Unexamined Patent Publication No. 2004-327223, and Japanese Unexamined Patent Publication No. 2010-192409, separate equipment for suppressing a change in the environmental temperature of a battery is required, which may cause an increase in the complexity of equipment configuration. In particular, in a case where air-conditioning equipment is used as in Japanese Unexamined Patent Publication No. 2011-038365, separate energy supply to the air-conditioning equipment is required, which may cause a problematic increase in energy consumption.

The present disclosure describes a power feeding system in which a vehicular battery can be appropriately kept warm with a simple equipment configuration.

A power feeding system according to one aspect of the present disclosure feeds power to a vehicle equipped with a battery. The power feeding system includes: an accommodation portion including a heat insulating material and configured to accommodate the vehicle; a power feeding unit configured to feed power to the battery of the vehicle accommodated in the accommodation portion; a power feeding controller configured to control the power feeding to the battery by the power feeding unit; and a temperature sensor configured to detect temperature inside the accommodation portion. The power feeding controller is configured to control the power feeding to the battery such that the temperature detected by the temperature sensor is within a temperature range suitable for keeping the battery warm.

### BRIEF DESCRIPTION OF THE DRAWINGS

FIG. 1 is a cross-sectional view in which a parking facility of a power feeding system according to one embodiment is seen from above.

FIG. 2 is a cross-sectional view in which the parking facility is seen from a side.

FIG. 3 is a side view in which the parking facility is seen from the opening portion side of an accommodation portion.

FIG. 4A is a cross-sectional view in which a vehicle that stops in the accommodation portion is seen from a side. FIG. 4B is a cross-sectional view in which the vehicle that stops in the accommodation portion is seen from behind.

FIG. 5 is a block diagram illustrating the configurations of the parking facility and a parking facility control device of the power feeding system.

FIG. 6 is a diagram illustrating a parking list that the parking facility control device refers to.

FIG. 7 is a block diagram illustrating the configuration of the vehicle.

FIG. 8 is a flowchart illustrating entry processing executed by the parking facility control device.

FIG. 9 is a flowchart illustrating power feeding processing executed by the parking facility control device.

FIG. 10 is a flowchart illustrating exit processing executed by the parking facility control device.

FIG. 11 is a flowchart illustrating charging processing executed by a vehicle control device.

FIG. 12 is a flowchart illustrating a modification example of the power feeding processing executed by the parking facility control device.

FIG. 13 is a cross-sectional view in which a modification example of the parking facility is seen from above.

FIG. 14 is a cross-sectional view in which the parking facility of FIG. 13 is seen from a side.

### DETAILED DESCRIPTION

A power feeding system according to one aspect of the present disclosure feeds power to a vehicle equipped with a battery. This power feeding system includes: an accommodation portion including a heat insulating material and configured to accommodate the vehicle; a power feeding unit configured to feed power to the battery of the vehicle accommodated in the accommodation portion; a power feeding controller configured to control the power feeding to the battery by the power feeding unit; and a temperature sensor configured to detect temperature inside the accommodation portion. The power feeding controller is configured to control the power feeding to the battery such that the temperature detected by the temperature sensor is within a temperature range suitable for keeping the battery warm.

In the power feeding system described above, the accommodation portion accommodating the vehicle is configured to include the heat insulating material. As a result, the heat that is generated from the battery or the like during power feeding to the vehicle can be retained in the accommodation portion. Further, in the power feeding system described above, power feeding to the battery is controlled such that the temperature inside the accommodation portion is within a temperature range suitable for keeping the battery warm. By controlling power feeding to the battery, it is possible to cause a change in the amount of heat in the accommodation portion entailed by the heat generation of the battery or the like, and thus the temperature inside the accommodation portion can be adjusted to a temperature range suitable for keeping the battery warm using the change in the amount of heat. With such a configuration that adjusts the temperature inside the accommodation portion using heat generated during power feeding, it is possible to appropriately keep the battery of the vehicle warm with simple equipment without requiring separate equipment for adjusting the temperature inside the accommodation portion.

The power feeding controller may be configured to instruct the power feeding unit to stop the power feeding to the battery in a case where the temperature detected by the temperature sensor is higher than an upper limit of the temperature range. In this case, a rise in temperature in the accommodation portion attributable to the heat generated during power feeding to the battery can be suppressed. As a result, the temperature inside the accommodation portion can be adjusted so as not to exceed the upper limit of the temperature range suitable for keeping the battery warm.

The power feeding controller may be configured to instruct the power feeding unit to start the power feeding to the battery in a case where the temperature detected by the temperature sensor is lower than a lower limit of the temperature range. In this case, a rise in temperature in the accommodation portion attributable to the heat generated during power feeding to the battery can be promoted. As a result, the temperature inside the accommodation portion can be adjusted so as not to fall below the lower limit of the temperature range suitable for keeping the battery warm.

The power feeding controller may be configured to output a signal instructing discharge of the battery to be started in a case where the temperature detected by the temperature sensor is lower than a lower limit of the temperature range and a charging rate of the battery is higher than a predetermined threshold. With this configuration, even in a case where the charging rate of the battery is high, it is possible to promote a rise in temperature in the accommodation portion using the heat generated during discharge by discharging the battery. As a result, the temperature inside the accommodation portion can be more reliably adjusted so as not to fall below the lower limit of the temperature range suitable for keeping the battery warm.

The temperature sensor may be installed at a position in the accommodation portion closer to a ceiling wall of the accommodation portion than to a floor surface of the accommodation portion. In this case, a situation in which the temperature sensor hinders movement of the vehicle can be suppressed as compared with a case where the temperature sensor is installed on the floor surface of the accommodation portion. The air warmed by the heat that is generated from the battery during power feeding is likely to rise by convection and stay near the ceiling wall, and thus the temperature detected by the temperature sensor installed at the position close to the ceiling wall can be appropriately used as the environmental temperature of the battery.

The power feeding unit may include a coil unit installed on a floor surface of the accommodation portion and configured to wirelessly transmit power to the battery. In this case, the heat generated from the coil unit as well as the heat generated from the battery during power feeding can be used to adjust the temperature inside the accommodation portion.

The coil unit may be exposed in the accommodation portion from the floor surface. In this case, the heat generated from the coil unit during power feeding is likely to stay in the accommodation portion, and thus the temperature inside the accommodation portion can be efficiently adjusted using the heat generated from the coil unit.

The power feeding unit may further include a power transmission circuit unit electrically connected to the coil unit and configured to transmit power to the coil unit, and the power transmission circuit unit may be installed at a position in the accommodation portion closer to the floor surface than to a ceiling wall of the accommodation portion. In this case, the heat generated from the power transmission circuit unit as well as the heat generated from the battery and the coil unit during power feeding can be used to adjust the temperature inside the accommodation portion. Further, by installing the power transmission circuit unit at the position close to the floor surface of the accommodation portion, the temperature inside the accommodation portion can be efficiently adjusted using the heat generated from the power transmission circuit unit.

The power feeding system may include a first power feeding unit as the power feeding unit and a second power feeding unit as the power feeding unit, in which the first power feeding unit and the second power feeding unit may be installed so as to be separated in a direction along a floor surface of the accommodation portion. In this case, a plurality of vehicles can be simultaneously fed with power using the plurality of power feeding units installed in the accommodation portion. As a result, the temperature inside the accommodation portion can be efficiently adjusted using the heat generated during power feeding to the battery of each vehicle. Further, by power feeding to the plurality of vehicles in the accommodation portion being possible as described above, it is possible to increase the possibility that the vehicle that requires power feeding is present in the accommodation portion. As a result, it is possible to continuously adjust the temperature inside the accommodation portion using the heat generated during power feeding.

The temperature sensor may be positioned between the first power feeding unit and the second power feeding unit in the direction along the floor surface of the accommodation portion. In this case, it is possible to bring the temperature sensor close to a position close to the battery of the vehicle while disposing the temperature sensor at a position that does not hinder movement of the vehicle in the accommodation portion. As a result, the temperature detected by the temperature sensor can be more appropriately used as the environmental temperature of the battery.

The power feeding system may further include a guidance controller configured to guide the vehicle into the accommodation portion, in which the accommodation portion may be provided with an opening portion configured for the vehicle to be capable of passing through the opening portion, a door portion configured to be capable of opening and closing the opening portion, and a passage sensor configured to detect whether or not the vehicle has passed through the opening portion. The guidance controller may be configured to control the door portion to be opened when the vehicle enters the accommodation portion from the opening portion and control the door portion to be closed when the passage sensor has detected that the vehicle has passed through the opening portion. In this case, the time during which the opening portion of the accommodation portion is opened can be minimized, and thus a situation in which the air warmed in the accommodation portion is released to the outside can be suppressed.

According to some aspects of the present disclosure, a power feeding system in which a vehicular battery can be appropriately kept warm with a simple equipment configuration is provided.

Hereinafter, an embodiment of the present invention will be described with reference to the drawings. In the drawings, the same reference numerals are given to the same or corresponding elements with redundant description omitted as appropriate.

<Configuration of Power Feeding System>

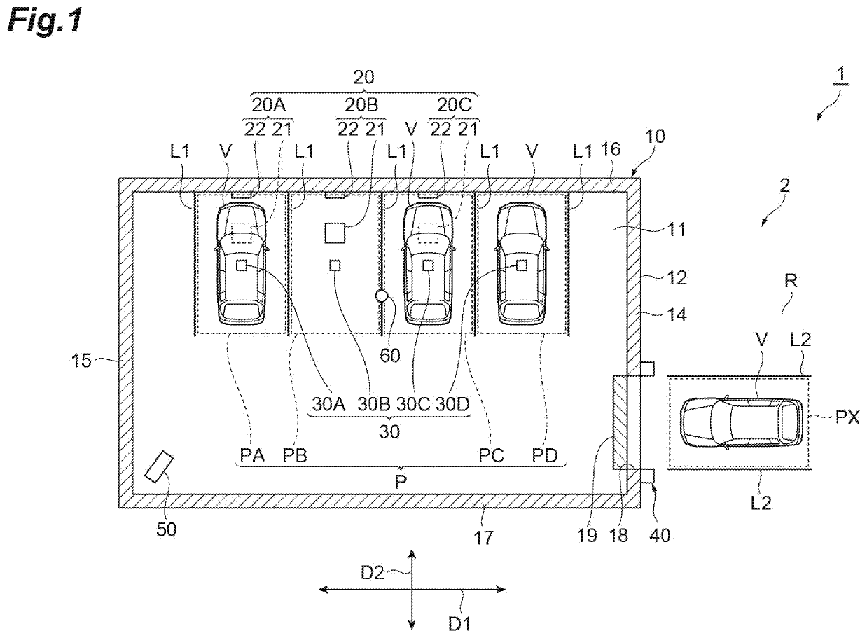

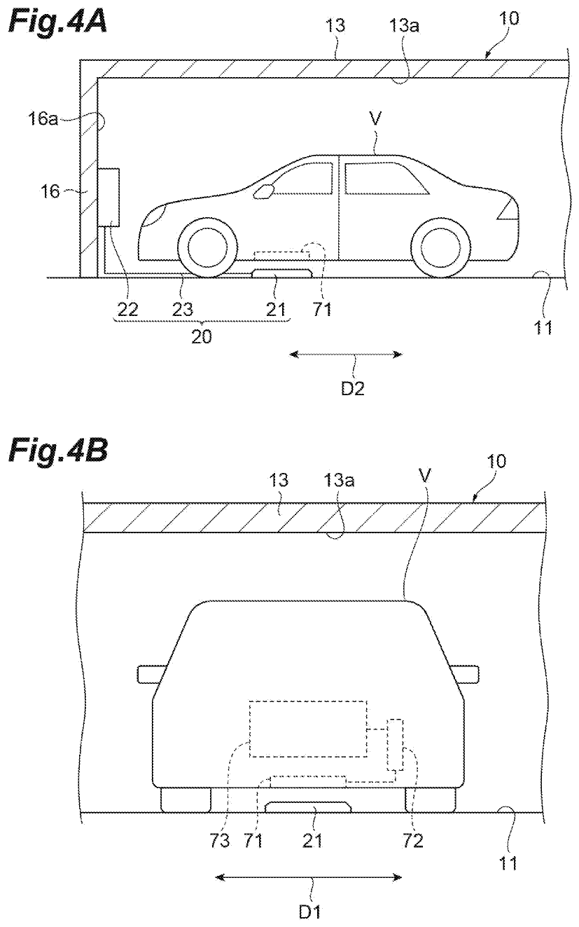

A power feeding system 1 illustrated in FIG. 1 is a system for power feeding to a vehicle V equipped with a battery 73 (see FIG. 4B). The vehicle V is an electric car that travels using the electric power of the battery 73. The electric car here may be an automobile provided with only an electric motor as a power source or may be a plug-in hybrid car provided with an electric motor and an internal combustion engine as power sources. In the present embodiment, a case where the vehicle V is a self-driving vehicle that self-travels will be exemplified. Based on instructions from the power feeding system 1, the vehicle V is capable of self-traveling to reach a predetermined position and being fed with power at the position. In other words, the vehicle V can be autonomously fed with power in an unmanned state.

In the following description, “lower” means the direction from the vehicle V toward a road surface R (vertical-direction lower side) in a state where the vehicle V is placed on the road surface R so as to be capable of traveling, and “upper” means the direction from the road surface R toward the vehicle V (vertical-direction upper side). One direction along the road surface R will be referred to as “direction D1”, and a direction that is along the road surface R and intersects the one direction will be referred to as “direction D2”.

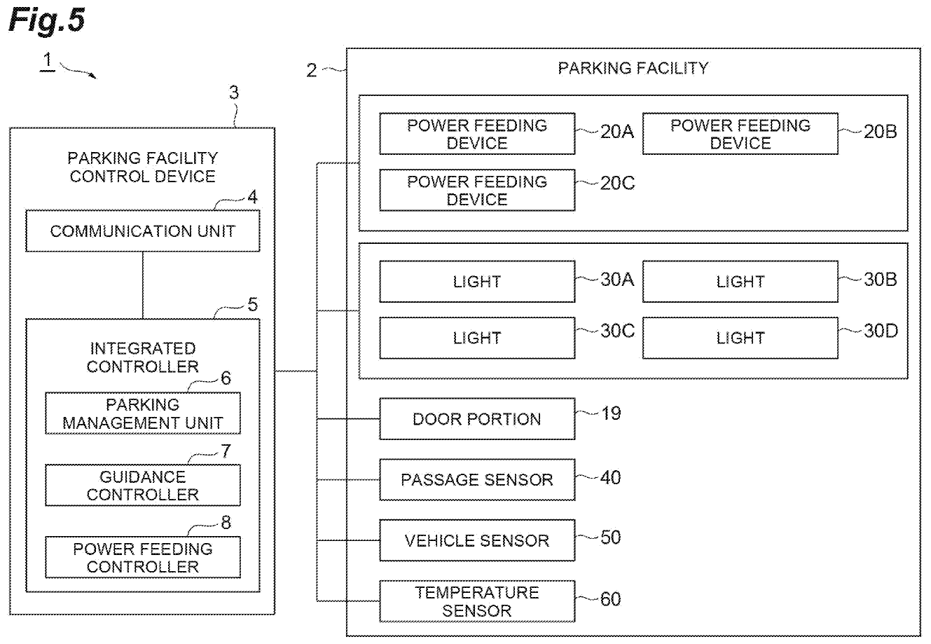

The power feeding system 1 includes a parking facility 2 and a parking facility control device 3 (see FIG. 5). The parking facility 2 is a facility for the vehicle V to park and be fed with power. As illustrated in FIG. 1, the parking facility 2 has, for example, an accommodation portion 10, a plurality of power feeding devices 20 (power feeding units), a plurality of lights 30, a passage sensor 40, a vehicle sensor 50, and a temperature sensor 60. The accommodation portion 10 is an accommodation facility capable of accommodating the vehicle V. The accommodation portion 10 has a size at which at least one vehicle V can be accommodated. In the present embodiment, the accommodation portion 10 is capable of accommodating a plurality (four in one example) of the vehicles V. The accommodation portion 10 is, for example, a building installed on the road surface R. The accommodation portion 10 may be an independent building or may be constituted by one room in a building having a plurality of rooms. The accommodation portion 10 may be a structure that simply covers the vehicle V.

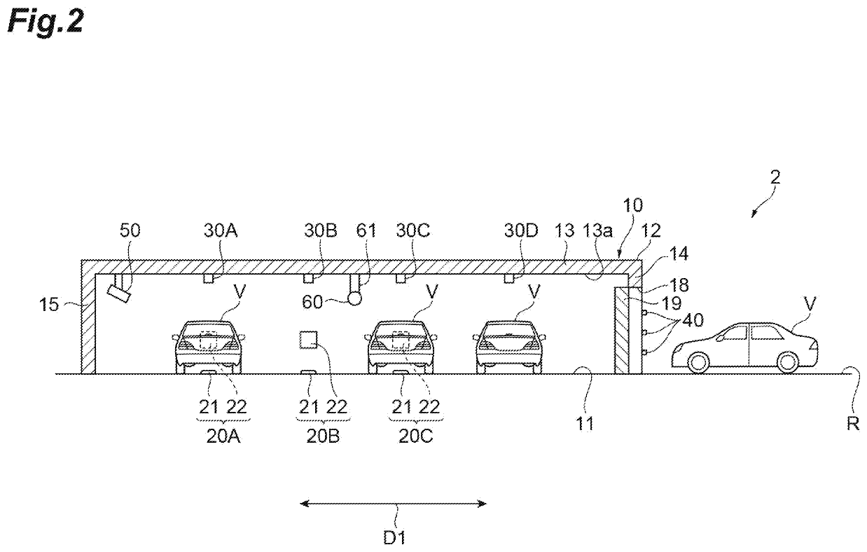

As illustrated in FIGS. 1 and 2, the accommodation portion 10 has, for example, a rectangular parallelepiped appearance in which the direction D1 is the longitudinal direction thereof. The accommodation portion 10 is configured to include a floor surface 11 and a wall portion 12. The floor surface 11 is, for example, a floor surface that constitutes the interior of a building and extends along the direction D1 and the direction D2. The floor surface 11 may be constituted by the road surface R provided on the ground. The wall portion 12 defines, with the floor surface 11, an internal space where at least one vehicle V can be accommodated. The wall portion 12 is configured to include, for example, a ceiling wall 13 (see FIG. 2) and four side walls 14, 15, 16, and 17. The side walls 14, 15, 16, and 17 have, for example, a rectangular shape extending upward from the floor surface 11. The side walls 14 and 15 are disposed so as to face each other in the direction D1, and the side walls 16 and 17 are disposed so as to face each other in the direction D2. As illustrated in FIG. 2, the ceiling wall 13 is provided so as to close the opening that is formed at the upper ends of the side walls 14, 15, 16, and 17 and faces the floor surface 11 in a vertical direction.

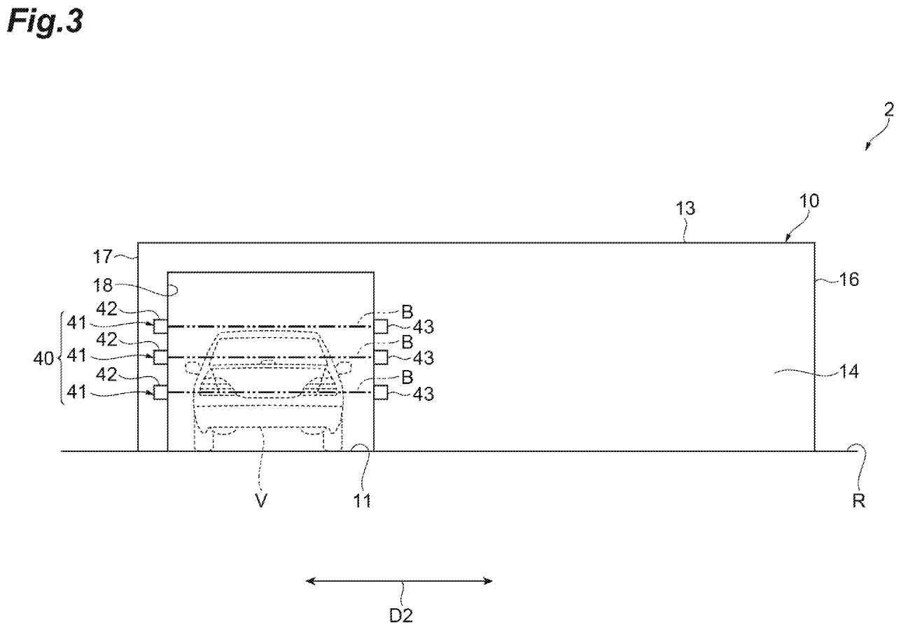

As illustrated in FIGS. 1 to 3, the side wall 14 is formed with an opening portion 18 for the vehicle V to enter or exit the accommodation portion 10. The opening portion 18 is, for example, a rectangular through hole penetrating the side wall 14 (see FIG. 3). The opening portion 18 has a size at which one vehicle V is capable of passing and allows the inside and the outside of the accommodation portion 10 to communicate with each other. The floor surface 11 of the accommodation portion 10 and the external road surface R are connected smoothly (that is, without a large step) via the opening portion 18. As a result, the vehicle V is capable of easily moving from the road surface R to the floor surface 11 and from the floor surface 11 to the road surface R. The road surface R is not limited to a road surface provided on the ground and may be, for example, a floor surface in a building insofar as the vehicle V is capable of traveling.

As illustrated in FIGS. 1 and 2, the accommodation portion 10 is provided with a door portion 19 for opening and closing the opening portion 18. The door portion 19 is, for example, an electric door portion that can be opened and closed based on instructions from the parking facility control device 3. An electric motor or compressed air is used as an example of power for the opening and closing operation of the door portion 19. In a case where the door portion 19 is in an open state, the opening portion 18 is opened and the inside and the outside of the accommodation portion 10 communicate with each other via the opening portion 18. Meanwhile, in a case where the door portion 19 is in a closed state, the opening portion 18 is closed and the inside of the accommodation portion 10 is blocked by the floor surface 11, the wall portion 12, and the door portion 19. The configuration of the door portion 19 is not particularly limited insofar as the opening portion 18 can be opened and closed. For example, the door portion 19 may be constituted by a pair of door members that electrically slide in the left-right direction to perform an opening and closing operation or may be constituted by a single door member that electrically rotates around a vertical axis to perform an opening and closing operation. The door portion 19 does not have to be an electric door portion. For example, the door portion 19 may be a manual door portion that can be opened and closed manually.

The wall portion 12 of the accommodation portion 10 is configured to include a heat insulating material that suppresses heat transfer between the inside and the outside of the accommodation portion 10. The heat insulating material is, for example, glass wool or the like. The heat insulating material is provided on a part or the whole of the wall portion 12. In the present embodiment, the heat insulating material is provided on the entire inner surface of the wall portion 12 and the entire inner surface of the door portion 19. As a result, thermal insulation is ensured between the inside and the outside of the accommodation portion 10. In a case where the door portion 19 is in a closed state, the inside of the accommodation portion 10 is blocked, and thus the thermal insulation between the inside and the outside of the accommodation portion 10 is enhanced. In this state, a minute gap may be formed in the accommodation portion 10, examples of which include a gap formed between the door portion 19 for an opening and closing operation and the side wall 14 and a gap attributable to dimensional error of members constituting the wall portion 12. However, except for such a minute gap, a path of air capable of flowing between the inside and the outside of the accommodation portion 10 is not formed. Therefore, in a case where the door portion 19 is in a closed state, extremely little air can flow between the inside and the outside of the accommodation portion 10, and thus the accommodation portion 10 is capable of exhibiting high thermal insulation.

A plurality of parking sections P are preset on the floor surface 11 of the accommodation portion 10. Each parking section P is a section defining the position where the vehicle V that has entered the accommodation portion 10 stops. One vehicle V can stop in each parking section P. The parking sections P are, for example, disposed side by side in the direction D1 on the floor surface 11. The parking sections P are partitioned by a plurality of section boundary lines L1 arranged at intervals in the direction D1. As an example, the section boundary lines L1 linearly extend in the direction D2 and are disposed side by side at regular intervals in the direction D1. Each section boundary line L1 may be, for example, a line drawn in a different color from the floor surface 11 (for example, a white line).

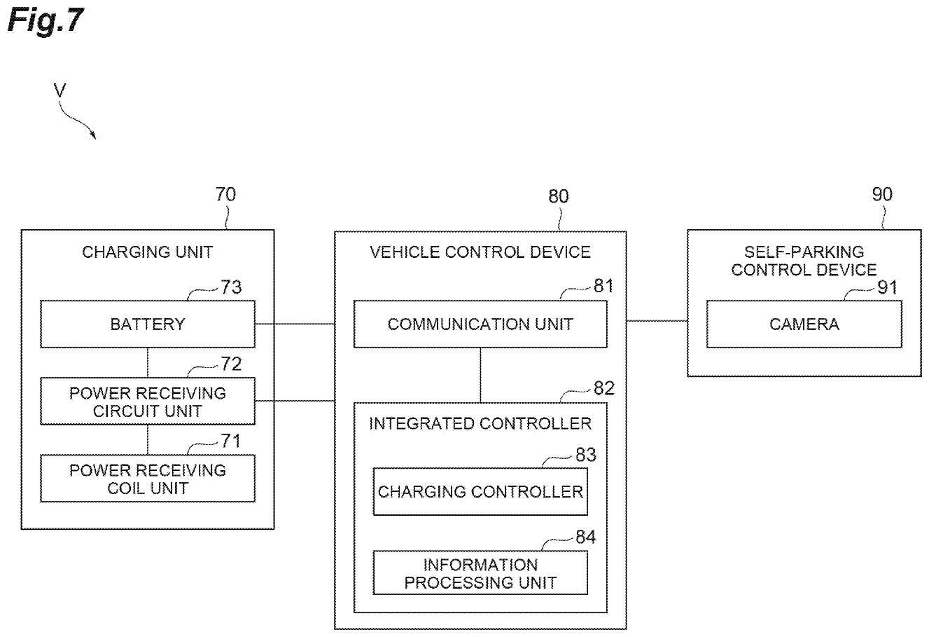

Each parking section P is defined as the region that is sandwiched between two section boundary lines L1 adjacent to each other in the direction D1. The vehicle V is capable of extracting two mutually adjacent section boundary lines L1 from an image captured by a mounted camera 91 (see FIG. 7) and grasping the region that is sandwiched between the two extracted section boundary lines L1 as the parking section P. Therefore, the section boundary line L1 serves as a mark for guiding the vehicle V to the parking section P. The parking section P is set such that the two section boundary lines L1 indicating the parking section P enter the imaging field of view of the camera 91 of the vehicle V that stops in a stop section PX set outside the accommodation portion 10. Each parking section P may have the same color as the floor surface 11 (that is, have a uniform appearance with the floor surface 11) or may be painted in a different color from the floor surface 11 and the section boundary line L1.

Although the example illustrated in FIG. 1 illustrates a case where four parking sections P are set, the number of parking sections P is not particularly limited. Only one parking section P may be set or two, three, or five or more parking sections P may be set on the floor surface 11. Although each parking section P in FIG. 1 is indicated by a dashed line in the interest of convenience, the dashed line does not have to be actually drawn on the floor surface 11. In the following description, the four parking sections P will be described as “parking section PA”, “parking section PB”, “parking section PC”, and “parking section PD” in order from the side wall 15 side in a case where the four parking sections P are described separately. The four parking sections P will be collectively described as “parking sections P” in a case where the four parking sections P are described without being distinguished.

As illustrated in FIG. 1, one stop section PX is preset on the road surface R outside the accommodation portion 10. The stop section PX is a section defining the position where the vehicle V that requests entry into the accommodation portion 10 stops temporarily. One vehicle V can stop in the stop section PX. The stop section PX is set at a position on the road surface R that is adjacent to the opening portion 18 of the accommodation portion 10 in the direction D1. The stop section PX is defined by two section boundary lines L2 provided on both sides in the direction D2. In other words, the stop section PX is defined as the region sandwiched between the two section boundary lines L2. The two section boundary lines L2 are disposed side by side with an interval in the direction D2 and linearly extend in the direction D1. The two section boundary lines L2 are, for example, lines drawn in a different color from the road surface R (for example, white lines).

The vehicle V is capable of extracting the two section boundary lines L2 from an image captured by the mounted camera 91 (see FIG. 7) and grasping the region sandwiched between the two extracted section boundary lines L2 as the stop section PX. The stop section PX may have the same color as the road surface R (that is, have a uniform appearance with the road surface R) or may be painted in a different color from the road surface R and the section boundary line L2. Although the stop section PX in FIG. 1 is indicated by a dashed line in the interest of convenience, the dashed line does not have to be actually drawn on the road surface R.

The plurality of power feeding devices 20 are installed side by side in the direction D1 so as to correspond to the plurality of parking sections P. In the present embodiment, the plurality of power feeding devices 20 are respectively installed in some of the plurality of parking sections P and are not installed in the other parking section P. Therefore, in the present embodiment, the parking section P where the power feeding device 20 is installed and the parking section P where the power feeding device 20 is not installed are present in the accommodation portion 10. In the example illustrated in FIG. 1, a power feeding device 20A is installed in the parking section PA, a power feeding device 20B is installed in the parking section PB, a power feeding device 20C is installed in the parking section PC, and the power feeding device 20 is not installed in the parking section PD. In the following description, the three power feeding devices 20A, 20B, and 20C will be collectively described as “power feeding devices 20” in a case where the three power feeding devices 20A, 20B, and 20C are described without being distinguished. One power feeding device 20 may be installed in each of all the parking sections P.

The power feeding device 20 is a device performing power feeding to the vehicle V that is stopped in the parking section P. A case where the power feeding device 20 wirelessly supplies power to the vehicle V is exemplified in the present embodiment. The power feeding method of the power feeding device 20 may be an electromagnetic induction method or may be another method such as a magnetic resonance method. As illustrated in FIG. 4A, the power feeding device 20 has, for example, a power transmission coil unit 21 (coil unit), a power transmission circuit unit 22, and a cable 23. The power transmission coil unit 21, the power transmission circuit unit 22, and the cable 23 are disposed so as not to hinder the movement of the vehicle V that enters and exits the parking section P.

The power transmission coil unit 21 is installed on, for example, the floor surface 11 of the parking section P. Specifically, the power transmission coil unit 21 is installed so as to protrude upward from the floor surface 11 and is exposed in the accommodation portion 10. The power transmission coil unit 21 is provided at the position that faces a power receiving coil unit 71 mounted in the vehicle V in the vertical direction when the vehicle V has stopped in the parking section P. The power transmission coil unit 21 may be embedded in the floor surface 11 and may not be exposed in the accommodation portion 10.

The power transmission circuit unit 22 is installed on, for example, an inner surface 16a of the side wall 16 of the parking section P. Specifically, the power transmission circuit unit 22 is installed so as to protrude in the direction D2 from the inner surface 16a and is exposed in the accommodation portion 10. The power transmission circuit unit 22 is, for example, installed at a height closer to the floor surface 11 than to the ceiling wall 13 on the inner surface 16a and faces, in the direction D2, the vehicle V that has stopped in the parking section P. The power transmission circuit unit 22 may be installed so as to be in contact with the floor surface 11. The power transmission circuit unit 22 may be embedded in the floor surface 11 or the side wall 16 and may not be exposed in the accommodation portion 10.

The cable 23 connects the power transmission coil unit 21 and the power transmission circuit unit 22. The cable 23 is laid on, for example, the floor surface 11 and the inner surface 16a and is exposed in the accommodation portion 10. The cable 23 extends from the power transmission coil unit 21 toward the side wall 16 on the floor surface 11 and extends upward along the inner surface 16a to reach the power transmission circuit unit 22. The cable 23 has strength that allows, for example, a tire of the vehicle V to ride thereon. The cable 23 may be embedded in the floor surface 11 or the side wall 16 and may not be exposed in the accommodation portion 10. A state where a certain configuration is exposed in the accommodation portion 10 may be a state where a part of the certain configuration is embedded in the floor surface 11 or the side wall 16, without the certain configuration necessarily having to protrude from the floor surface 11, the inner surface 16a, or the like, insofar as at least a part of the certain configuration is in contact with the internal space of the accommodation portion 10. A part exposed in the accommodation portion 10 may be the outermost portion of a certain configuration. For example, in a case where the power transmission coil unit 21 has a housing in the outermost portion thereof, at least a part of the housing portion may be exposed in the accommodation portion 10.

The power transmission circuit unit 22 converts electric power supplied from an external power source into high-frequency AC (alternating current) power and supplies the high-frequency AC power resulting from the conversion to the power transmission coil unit 21 via the cable 23. The external power source may be, for example, a commercial power source or the like of 50 Hz or 60 Hz. Electric power of solar power generation, wind power generation, and so on may be used as the external power source or electric power in which the electric power of a battery is combined for stabilization with electric power of solar power generation, wind power generation, and so on may be used as the external power source. The power transmission circuit unit 22 may receive the input of AC or DC (direct current) power from the external power source, perform conversion into DC power with a predetermined voltage using a power factor correction (PFC) circuit, a rectifier, a DC-DC converter, and so on, and perform further conversion into high-frequency AC power using an inverter. The frequency of the AC power that the power transmission circuit unit 22 supplies to the power transmission coil unit 21 may be, for example, 100 kHz. The power factor correction circuit can be omitted in a case where the electric power supplied from the external power source is DC power. The power transmission circuit unit 22 is capable of starting and stopping power feeding to the vehicle V based on instructions from the parking facility control device 3.

The power transmission coil unit 21 wirelessly transmits power to the vehicle V. The power transmission coil unit 21 converts the high-frequency AC power supplied via the cable 23 into a magnetic field. The magnetic field generated by the power transmission coil unit 21 causes the power receiving coil unit 71 mounted in the vehicle V to generate an electromotive force by electromagnetic induction. As a result, wireless power transmission to the power receiving coil unit 71 is performed. The power transmission coil unit 21 includes, for example, a circular coil and a capacitor and an inductor for wireless power transmission efficiency enhancement. However, the internal configuration of the power transmission coil unit 21 may be another configuration insofar as power can be wirelessly transmitted to the power receiving coil unit 71.

As illustrated in FIGS. 1 and 2, the plurality of lights 30 are disposed at positions respectively corresponding to the plurality of parking sections P. The positions respectively corresponding to the plurality of parking sections P may be, for example, positions respectively facing the floor surfaces 11 of the plurality of parking sections P in the vertical direction. In the present embodiment, the lights 30 are installed on an inner surface 13a of the ceiling wall 13 so as to be arranged at regular intervals in the direction D1, and each light 30 is disposed so as to face, in the vertical direction, the middle of the floor surface 11 of the corresponding parking section P (that is, the intermediate position between the two section boundary lines L1 sandwiching the corresponding parking section P).

In the present embodiment, a light 30A is installed above the middle of the parking section PA, a light 30B is installed above the middle of the parking section PB, a light 30C is installed above the middle of the parking section PC, and a light 30D is installed above the middle of the parking section PD. In the following description, the four lights 30A, 30B, 30C, and 30D will be collectively referred to as “lights 30” in a case where the four lights 30A, 30B, 30C, and 30D are described without being distinguished.

The light 30 may be, for example, a white light-emitting diode. In this case, the light 30 is driven by a power source and an electronic control element such as a power MOSFET. The light 30 switches between on and off based on instructions from the parking facility control device 3. Specifically, in accordance with an instruction from the parking facility control device 3, one of the plurality of lights 30 is controlled to be turned on and the other lights 30 are controlled to be turned off. The light 30 that is turned on illuminates the two section boundary lines L1 sandwiching the corresponding parking section P. The vehicle V is capable of recognizing the two section boundary lines L1 illuminated by the light 30 that is turned on from an image captured by the mounted camera 91 and self-traveling to the parking section P sandwiched between the two recognized section boundary lines L1, which is a target position.

The passage sensor 40 is installed around the opening portion 18 in the accommodation portion 10 and detects whether or not the vehicle V has passed through the opening portion 18. As illustrated in FIG. 3, the passage sensor 40 has, for example, a plurality (three in the present embodiment) of sensor units 41. The sensor units 41 are, for example, installed at the edge portion of the opening portion 18 and at intervals in the vertical direction so as to be mutually different in height. The height of each sensor unit 41 is set in accordance with the height of the vehicle V that is capable of passing through the opening portion 18. At least one of the sensor units 41 is installed at a position lower than the lowest vehicle V that is capable of passing through the opening portion 18.

Each sensor unit 41 is constituted by an irradiation unit 42 emitting a laser beam B and a light receiving unit 43 receiving the laser beam B from the irradiation unit 42. The irradiation unit 42 and the light receiving unit 43 are disposed so as to face each other in the direction D2 with the opening portion 18 interposed therebetween. In a case where the vehicle V has not passed through the opening portion 18, the laser beam B emitted from the irradiation unit 42 is received by the corresponding light receiving unit 43 in every sensor unit 41. Meanwhile, in a case where the vehicle V is passing through the opening portion 18, the laser beam B emitted from the irradiation unit 42 is blocked by the vehicle V passing through the opening portion 18 in at least one sensor unit 41, and thus the laser beam B is not received by the light receiving unit 43. Then, after the vehicle V passes through the opening portion 18, the laser beam B blocked by the vehicle V is received again by the light receiving unit 43.

Therefore, while the laser beam B is received by the light receiving unit 43 in every sensor unit 41, the passage sensor 40 determines that the vehicle V is not passing through the opening portion 18. Meanwhile, while the reception of the laser beam B by the light receiving unit 43 is blocked in at least one sensor unit 41, the passage sensor 40 determines that the vehicle V is passing through the opening portion 18. Then, when the light receiving unit 43 blocked from receiving the laser beam B has become capable of receiving the laser beam B again, the passage sensor 40 determines that the vehicle V has passed through the opening portion 18 (that is, the passage of the vehicle V through the opening portion 18 has ended). Therefore, when the light receiving unit 43 has become capable of receiving the laser beam B again after the reception of the laser beam B by the light receiving unit 43 is blocked in at least one sensor unit 41, the passage sensor 40 detects that the vehicle V has passed through the opening portion 18. The detection result of the passage sensor 40 is transmitted to the parking facility control device 3.

The configuration of the passage sensor 40 is not limited to the configuration described above. For example, the passage sensor 40 may be configured to have only one sensor unit 41. Alternatively, the passage sensor 40 may be configured to have a camera instead of the sensor unit 41. In this case, the passage sensor 40 detects whether or not the vehicle V has passed through the opening portion 18 from an image captured by the camera.

The vehicle sensor 50 illustrated in FIGS. 1 and 2 is installed in the accommodation portion 10 and detects whether or not the vehicle V is stopped in the parking section P in the accommodation portion 10. The vehicle sensor 50 recognizes the presence or absence of the vehicle V in each parking section P using, for example, a camera capable of photographing every parking section P. The vehicle sensor 50 detects the stop of the vehicle V in the parking section P in a case where the presence of the vehicle V in the parking section P can be recognized from the image captured by the camera. Meanwhile, the vehicle sensor 50 does not detect the stop of the vehicle V in the parking section P in a case where the presence of the vehicle V in the parking section P cannot be recognized from the image captured by the camera. The detection result of the vehicle sensor 50 is transmitted to the parking facility control device 3.

The vehicle sensor 50 is not particularly limited in type. For example, the vehicle sensor 50 may be a sensor that is embedded in the floor surface 11 of each parking section P and detects metal within a predetermined range on the floor surface 11 (for example, the range from the floor surface 11 to several tens of centimeters above). In this case, the vehicle sensor 50 detects the stop of the vehicle V in the parking section P in a case where the metal part provided on the lower surface of the vehicle V is detected. Meanwhile, in a case where the metal part provided on the lower surface of the vehicle V is not detected, the vehicle sensor 50 does not detect the stop of the vehicle V in the parking section P.

The temperature sensor 60 is installed in the accommodation portion 10 to detect the temperature inside the accommodation portion 10. The temperature inside the accommodation portion 10 is the temperature of the air that is present in the accommodation portion 10. As illustrated in FIG. 2, the temperature sensor 60 is installed at, for example, a position closer to the inner surface 13a of the ceiling wall 13 than to the floor surface 11. In the present embodiment, the temperature sensor 60 is installed on the inner surface 13a of the ceiling wall 13 via a support portion 61 and is disposed at a position misaligned downward from the inner surface 13a of the ceiling wall 13. The height of the temperature sensor 60 may be, for example, a position lower than the inner surface 13a of the ceiling wall 13 and higher than the tallest vehicle V that is capable of entering the accommodation portion 10.

As illustrated in FIG. 1, the temperature sensor 60 is disposed at a position that overlaps, for example, the section boundary line L1 between the two parking sections P adjacent to each other when viewed from above. In the example illustrated in FIG. 1, the temperature sensor 60 is disposed above the section boundary line L1 between the parking section PB where the power feeding device 20B is installed and the parking section PC where the power feeding device 20C is installed. By disposing the temperature sensor 60 between the mutually adjacent power feeding device 20B (first power feeding unit) and power feeding device 20C (second power feeding unit) in this manner, the possibility of the temperature sensor 60 hindering movement of the vehicle V is reduced. As will be described later, the air warmed by the heat generated in the battery 73 or the like during power feeding to the vehicle V rises by convection in the accommodation portion 10, and thus the temperature detected by the temperature sensor 60 installed above can be appropriately used as the environmental temperature around the battery 73. The detection result of the temperature sensor 60 (that is, the temperature inside the accommodation portion 10 detected by the temperature sensor 60) is transmitted to the parking facility control device 3.

The configuration of the temperature sensor 60 is not limited to the configuration described above. For example, the temperature sensor 60 may be installed at a position between the parking section PB and the parking section PC that is lower than the height of the vehicle V that may stop in the parking section PB or the parking section PC (for example, a position closer to the floor surface 11 than to the inner surface 13a of the ceiling wall 13). In this case, it is possible to bring the temperature sensor 60 closer to the battery 73 mounted in the vehicle V that stops in the parking section P while avoiding a situation in which the temperature sensor 60 hinders movement of the vehicle V. As a result, the temperature detected by the temperature sensor 60 can be more appropriately used as the environmental temperature of the battery 73.

A plurality of the temperature sensors 60 may be installed in the accommodation portion 10. For example, one temperature sensor 60 may be installed on the section boundary line L1 between the parking sections PA and PB and another temperature sensor 60 may be installed on the section boundary line L1 between the parking sections PC and PD. In this case, the temperature detected by the temperature sensor 60 between the parking sections PA and PB may be used as the environmental temperature of the battery 73 of the vehicle V that stops in the parking sections PA and PB. The temperature detected by the temperature sensor 60 between the parking sections PC and PD may be used as the environmental temperature of the battery 73 of the vehicle V that stops in the parking sections PC and PD. Alternatively, the average value of the temperatures detected by the plurality of temperature sensors 60 may be used as the environmental temperature of the battery 73 of the vehicle V that stops in any of the parking sections P.

The parking facility control device 3 illustrated in FIG. 5 performs various types of control with respect to the parking facility 2. The parking facility control device 3 may be provided inside the accommodation portion 10 or may be provided outside the accommodation portion 10. The parking facility control device 3 is configured as, for example, a computer including a communication unit 4 and an integrated controller 5. The communication unit 4 is a communication device that communicates with the parking facility 2 and the vehicle V. The communication unit 4 includes a wireless communication device and performs wireless communication with the vehicle V. The communication unit 4 performs wired communication or wireless communication with the parking facility 2. In a case where it is difficult for the accommodation portion 10 to pass radio waves for communication (for example, in a case where the wall portion 12 of the accommodation portion 10 contains metal), wireless communication devices may be provided both inside and outside the accommodation portion 10. In this case, wireless communication between the vehicle V and the communication unit 4 is possible regardless of whether the vehicle V is positioned inside or outside the accommodation portion 10.

The integrated controller 5 is a processing unit that executes various types of control such as guidance of the vehicle V and power feeding. The integrated controller 5 is constituted by, for example, an electronic control unit including a microprocessor, a memory, a storage device storing an operation-defining program, and so on. The integrated controller 5 implements various functions by, for example, loading the program stored in the storage device into the memory and executing the program loaded into the memory with the microprocessor. The integrated controller 5 performs control such that movement of the vehicle V is guided between the parking section P and the stop section PX and power feeding to the vehicle V is performed in the parking section P. In order to perform these processes, the integrated controller 5 has, for example, a parking management unit 6, a guidance controller 7, and a power feeding controller 8 as functional configurations.

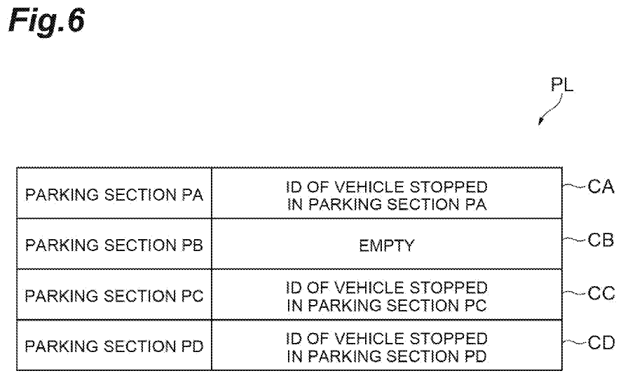

The parking management unit 6 manages information related to the parking situation of the vehicle V in the parking section P. In a case where the vehicle V intends to enter the accommodation portion 10, the vehicle V stops in the stop section PX and transmits an entry request signal to the parking facility control device 3. At this time, the driver alights from the vehicle V and the vehicle V becomes self-drivable. The parking management unit 6 includes a parking list PL (see FIG. 6) indicating the parking situation of the vehicle V in the parking section P. The parking list PL is kept in, for example, the memory of the integrated controller 5.

The parking list PL illustrated in FIG. 6 is provided with storage fields CA, CB, CC, and CD respectively corresponding to the parking sections PA, PB, PC, and PD. Information indicating whether or not the vehicles V are respectively stopped in the corresponding parking sections PA, PB, PC, and PD is stored in the storage fields CA, CB, CC, and CD. In a case where the vehicles V are respectively stopped in the parking sections PA, PC, and PD as illustrated in FIG. 1, the IDs of the vehicles V stopped in the parking sections PA, PC, and PD are respectively written to the storage fields CA, CC, and CD as illustrated in FIG. 6. The ID of the vehicle V is, for example, transmitted from the vehicle V together with the entry request signal.

Meanwhile, the vehicle V is not stopped in the parking section PB, and thus “empty” is written to the storage field CB. The parking management unit 6 determines whether or not the vehicle V is stopped in each parking section P by referring to the parking list PL. The parking management unit 6 may, for example, acquire the detection result from the vehicle sensor 50 at a predetermined timing, such as when the entry request signal from the vehicle V is received, and update the parking list PL based on the detection result.

The parking management unit 6 determines that the vehicle V is incapable of entering the parking section P in a case where it is determined that the vehicle V is stopped in every parking section P, that is, in a case where it is determined that there is no parking section P where “empty” is stored in the parking list PL. In this case, the parking management unit 6 transmits, to the vehicle V, a no-entry signal indicating that the vehicle V is incapable of entering the parking section P. The no-entry signal may be a signal notifying that there is no parking section P that the vehicle V is capable of entering or may be a signal instructing the vehicle V not to head for the parking section P.

Meanwhile, the parking management unit 6 determines that the vehicle V is capable of entering the parking section P in a case where it is determined that the vehicle V is not stopped in at least one parking section P, that is, in a case where it is determined that there is a parking section P where “empty” is stored in the parking list PL. In this case, the parking management unit 6 selects one parking section P that is empty. In a case where only one parking section PB is empty as in the present embodiment, the parking management unit 6 selects the one empty parking section PB. Meanwhile, in a case where a plurality of parking sections P are empty, the parking management unit 6 selects any one of the plurality of empty parking sections P by, for example, the following method.

For example, in a case where the power feeding device 20 is installed in every empty parking section P or in a case where the power feeding device 20 is not installed in every empty parking section P, the parking management unit 6 selects arbitrary one of all the empty parking sections P. The arbitrary one parking section P may be, for example, the parking section PA with the smallest number in a case where the parking sections PA, PB, and PC where the power feeding device 20 is installed are numbered 1, 2, and 3, respectively. Meanwhile, in a case where the parking section P where the power feeding device 20 is installed and the parking section P where the power feeding device 20 is not installed are mixed in the plurality of empty parking sections P, the parking management unit 6 selects arbitrary one of all the parking sections P where the power feeding device 20 is installed (for example, the parking section P with the smallest number in a case where each parking section P is numbered). In other words, the parking management unit 6 preferentially selects the parking section P where the power feeding device 20 is installed over the parking section P where the power feeding device 20 is not installed.

In a case where the parking section P where the power feeding device 20 is installed and the parking section P where the power feeding device 20 is not installed are mixed in the plurality of empty parking sections P, the parking management unit 6 may select any one parking section P based on the charging rate (state of charge (SOC)) of the battery 73 of the vehicle V. In this case, the parking management unit 6 acquires battery information indicating the charging rate of the battery 73 from the vehicle V. Then, the parking management unit 6 determines whether or not the charging rate of the battery 73 is high by referring to the battery information. For example, the parking management unit 6 may determine that the charging rate of the battery 73 is high in a case where the charging rate of the battery 73 is higher than 95% and determine that the charging rate of the battery 73 is low in a case where the charging rate of the battery 73 is 95% or less.

In a case where it is determined that the charging rate of the battery 73 is high, the parking management unit 6 selects, out of the empty parking sections P, arbitrary one parking section P where the power feeding device 20 is not installed. Meanwhile, in a case where it is determined that the battery 73 of the vehicle V is low, the parking management unit 6 selects, out of the empty parking sections P, arbitrary one parking section P where the power feeding device 20 is installed. In other words, the parking management unit 6 preferentially selects the parking section P where the power feeding device 20 is installed with respect to the vehicle V in which the charging rate of the battery 73 is low. As a result, the vehicle V with a low charging rate can be preferentially fed with power over the vehicle V with a high charging rate, and a situation in which the vehicle V becomes incapable of traveling due to the battery 73 being low can be suppressed.

Assumed is a situation in which a plurality of vehicles V intend to successively enter the accommodation portion 10 in a case where the power feeding device 20 is installed in every empty parking section P. For example, in a case where the parking sections PA, PB, and PC where the power feeding device 20 is installed are all empty and two vehicles V intend to enter the accommodation portion 10, the parking management unit 6 successively selects arbitrary two of the parking sections PA, PB, and PC. In this case, the parking management unit 6 may select two parking sections P in view of the disposition of each parking section P. In other words, the parking management unit 6 may select two parking sections P such that the two parking sections P are disposed to be evenly distributed in the horizontal direction in the accommodation portion 10.

For example, the parking management unit 6 may select the two parking sections PA and PC, which are on both sides with the parking section PB interposed therebetween, instead of the two mutually adjacent parking sections PA and PB (or parking sections PB and PC). As will be described later, the power feeding device 20 installed in the parking section P where power feeding to the vehicle V is performed serves as a heat source that generates heat when the vehicle V is fed with power. By distributing the two parking sections PA and PC, which serve as heat sources in this manner, in the horizontal direction (direction D1 in the present embodiment), the temperature inside the accommodation portion 10 can be raised evenly. Such a selection method is also effective in a case where sufficient electric power cannot be supplied to every power feeding device 20. For example, in a case where only two power feeding devices 20 can be supplied with sufficient electric power, the parking management unit 6 is capable of evenly raising the temperature inside the accommodation portion 10 by selecting the two parking sections PA and PC, which are separated from each other for heat source distribution in the horizontal direction.

The guidance controller 7 guides the vehicle V by controlling the lighting of the light 30, controlling the opening and closing of the door portion 19, and instructing the vehicle V to enter or exit. The guidance controller 7 is capable of instructing the vehicle V to enter or exit by transmitting an entry permission signal or an exit permission signal to the vehicle V.

In a case where a parking section P is selected by the parking management unit 6, the guidance controller 7 first performs control such that only the light 30 corresponding to the selected parking section P is turned on. As a result, the lights 30 corresponding to the other, that is, unselected parking sections P are turned off. Next, the guidance controller 7 controls the door portion 19 of the accommodation portion 10 to be opened, and then transmits the entry permission signal to permit the vehicle V stopped in the stop section PX to enter the selected parking section P. The entry permission signal may be a signal notifying that the selected parking section P is empty or may be a signal instructing the vehicle V to head for the selected parking section P. At this time, the guidance controller 7 may acquire the detection result of a human sensor installable in the vehicle V in order to confirm that the vehicle V is in an unmanned state. In this case, the guidance controller 7 may transmit the entry permission signal to the vehicle V after confirming that the vehicle V is in an unmanned state based on the detection result of the human sensor.

When the entry permission signal is received by the vehicle V, the vehicle V recognizes, with the mounted camera 91, the two section boundary lines L1 illuminated by the light 30 that is turned on. Then, the vehicle V self-travels to the parking section P indicated by the recognized section boundary lines L1. At this time, since the other lights 30 are off, the vehicle V is capable of recognizing the two section boundary lines L1 illuminated by the light 30 that is turned on. When the vehicle V has passed through the opening portion 18 while moving from the stop section PX to the parking section P, the guidance controller 7 receives, from the passage sensor 40, a detection result indicating that the vehicle V has passed through the opening portion 18. Upon receiving the detection result from the passage sensor 40, the guidance controller 7 controls the door portion 19 of the accommodation portion 10 to be closed. The vehicle V self-travels in the accommodation portion 10 with the door portion 19 closed and arrives in the selected parking section P.

Upon arriving in the selected parking section P, the vehicle V transmits, to the parking facility control device 3, an entry end signal indicating that entry into the parking section P has ended. Upon receiving the entry end signal from the vehicle V, the guidance controller 7 controls the light 30 that is on to be turned off. At this time, the parking management unit 6 writes, to the storage field in the parking list PL that corresponds to the selected parking section P, the ID of the vehicle V that has stopped in the parking section P. Upon arriving in the selected parking section P, the vehicle V is fed with power in the parking section P.

In causing the vehicle V to exit the parking section P, the guidance controller 7 transmits the exit permission signal to the vehicle V stopped in any of the parking sections P. In this case, the guidance controller 7 determines whether or not an exit request signal requesting exit of the vehicle V from the parking facility 2 has been received. The exit request signal is, for example, transmitted from the outside of the parking facility 2 to the parking facility control device 3 by the user of the vehicle V. Upon receiving the exit request signal, the guidance controller 7 identifies the vehicle V to exit by referring to the ID. At this time, the parking management unit 6 writes “empty” to the storage field in the parking list PL that corresponds to the parking section P where the vehicle V to exit is stopped.

Next, the guidance controller 7 controls the door portion 19 of the accommodation portion 10 to be opened, and then transmits the exit permission signal to permit the vehicle V to exit the parking section P. The exit permission signal may be, for example, a signal notifying that exit from the parking section P is permitted or a signal instructing the vehicle V to head for the stop section PX. Upon receiving the exit permission signal, the vehicle V to exit recognizes the two section boundary lines L2 outside the opening portion 18 with the mounted camera 91. Then, the vehicle V self-travels to the stop section PX indicated by the recognized section boundary lines L2.

When the vehicle V has passed through the opening portion 18 while moving from the parking section P to the stop section PX, the guidance controller 7 receives, from the passage sensor 40, a detection result indicating that the vehicle V has passed through the opening portion 18. Upon receiving the detection result from the passage sensor 40, the guidance controller 7 controls the door portion 19 of the accommodation portion 10 to be closed. Upon the vehicle V arriving in the stop section PX, the user who has transmitted the exit request signal boards the vehicle V. As described above, the guidance controller 7 is capable of guiding movement of the vehicle V between the stop section PX and the parking section P by controlling the lighting of the light 30, controlling the opening and closing of the door portion 19, and instructing the vehicle V to enter or exit.

The power feeding controller 8 controls power feeding to the vehicle V that is stopped in the parking section P where the power feeding device 20 is installed. The power feeding controller 8 controls the power feeding to the vehicle V by instructing the power transmission circuit unit 22 of the power feeding device 20 to start or stop power feeding. First, the power feeding controller 8 determines whether or not the vehicle V is stopped in the parking section P where the power feeding device 20 is installed. In a case where it is determined that the vehicle V is not stopped in the parking section P where the power feeding device 20 is installed, the power feeding controller 8 instructs the power feeding device 20 to stop power feeding. Meanwhile, in a case where it is determined that the vehicle V is stopped in the parking section P where the power feeding device 20 is installed, the power feeding controller 8 acquires the ID of the vehicle V stopped in the parking section P. At this time, the power feeding controller 8 also acquires, from the vehicle V, battery information indicating the charging rate of the battery 73 of the vehicle V.

Next, the power feeding controller 8 determines whether or not the charging rate of the battery 73 of the vehicle V stopped in the parking section P where the power feeding device 20 is installed is higher than a predetermined threshold. The predetermined threshold may be a charging rate value (for example, 95%) that can be regarded as a state where the battery 73 is fully charged. In a case where it is determined that the charging rate of the battery 73 is higher than the predetermined threshold (for example, more than 95%), the power feeding controller 8 determines that the battery 73 is fully charged and instructs the power feeding device 20 to stop power feeding to the vehicle V. Meanwhile, in a case where it is determined that the charging rate of the battery 73 is not higher than the predetermined threshold (for example, 95% or less), the power feeding controller 8 acquires the detection result of the temperature sensor 60.

Next, the power feeding controller 8 determines whether or not the temperature inside the accommodation portion 10 detected by the temperature sensor 60 is higher than the upper limit of a predetermined temperature range determined in advance. The predetermined temperature range is a temperature range suitable for keeping the battery 73 warm. Usually, a secondary battery that operates in a normal temperature environment is used as the battery 73 mounted in the vehicle V such as an electric car. Such a battery 73 stably exhibits performance required as specifications (for example, life characteristics and output characteristics) in a normal temperature environment. Therefore, the temperature range suitable for keeping the battery 73 warm may be a normal temperature range in which desired performance that is required can be exhibited. The normal temperature range may be, for example, the range of 20° C.±15° C. (that is, the range of 5° C. or higher and 35° C. or lower). The temperature range suitable for keeping the battery 73 warm can be changed in accordance with the type of the battery 73 and so on. For example, in a case where a lithium-ion secondary battery is used as the battery 73, the temperature range suitable for keeping the battery 73 warm may be the range of 20° C. or higher and 30° C. or lower.

In a case where the environmental temperature of the battery 73 is out of the temperature range described above, the battery 73 is incapable of stably exhibiting the performance required as specifications. For example, the battery 73 undergoes a phenomenon such as a decrease in charge capacity and a decrease in life attributable to self-discharge. Such a decline in the performance of the battery 73 becomes more conspicuous as the environmental temperature of the battery 73 deviates from the temperature range described above. Such a phenomenon also arises in a battery that is used at a normal temperature other than a lithium-ion secondary battery (for example, lead secondary battery or nickel-hydrogen secondary battery).

In a case where it is determined that the temperature detected by the temperature sensor 60 is higher than the upper limit (for example, 30° C.) of the temperature range suitable for keeping the battery 73 warm, the power feeding controller 8 instructs the power feeding device 20 to stop power feeding to the vehicle V. Meanwhile, in a case where it is determined that the temperature detected by the temperature sensor 60 is not higher than the upper limit of the temperature range suitable for keeping the battery 73 warm, the power feeding controller 8 determines whether or not the temperature is lower than the lower limit (for example, 20° C.) of the temperature range suitable for keeping the battery 73 warm. In a case where it is determined that the temperature detected by the temperature sensor 60 is lower than the lower limit of the temperature range suitable for keeping the battery 73 warm, the power feeding controller 8 instructs the power feeding device 20 to start power feeding to the vehicle V. Meanwhile, in a case where it is determined that the temperature detected by the temperature sensor 60 is not lower than the lower limit of the temperature range suitable for keeping the battery 73 warm, the power feeding controller 8 does not instruct the power feeding device 20 to start or stop power feeding. In this case, the power feeding to the vehicle V by the power feeding device 20 continues on condition that the power feeding device 20 is feeding power to the vehicle V and the power feeding to the vehicle V by the power feeding device 20 is not performed on condition that the power feeding device 20 is not feeding power to the vehicle V. In a case where the power feeding controller 8 receives the exit request signal, the power feeding controller 8 instructs the power feeding device 20 to stop power feeding to the vehicle V to exit.

The power feeding controller 8 repeatedly executes the above-described processing with respect to each parking section P. To summarize the above-described processing, the power feeding controller 8 instructs the power feeding device 20 to stop power feeding in a case where the charging rate of the battery 73 is higher than a predetermined threshold (for example, 95%) and in a case where the charging rate of the battery 73 is not higher than the predetermined threshold and the temperature detected by the temperature sensor 60 is higher than the upper limit (for example, 30° C.) of the predetermined temperature range. Meanwhile, the power feeding controller 8 instructs the power feeding device 20 to start power feeding in a case where the charging rate of the battery 73 is not higher than the predetermined threshold and the temperature detected by the temperature sensor 60 is lower than the lower limit (for example, 20° C.) of the predetermined temperature range.

With the power feeding device 20 feeding power to the vehicle V, the amount of heat in the accommodation portion 10 increases due to the heat generation of the battery or the like during the power feeding to the vehicle V in the accommodation portion 10, and thus the temperature inside the accommodation portion 10 rises accordingly. Meanwhile, with the power feeding device 20 feeding no power to the vehicle V, an increase in the amount of heat in the accommodation portion 10 is suppressed, and thus a rise in temperature in the accommodation portion 10 is suppressed. In this case, the temperature inside the accommodation portion 10 may fall by being affected by the outside air temperature. In this manner, the power feeding controller 8 is capable of adjusting the temperature inside the accommodation portion 10 by controlling the power feeding start instruction or the power feeding stop instruction to the power feeding device 20.

While the power feeding controller 8 repeats the above-described processing, the power feeding controller 8 instructs the power feeding device 20 to stop power feeding in a case where the temperature inside the accommodation portion 10 rises to become higher than the upper limit of the predetermined temperature range after the power feeding controller 8 instructs the power feeding device 20 to start power feeding. Conversely, the power feeding controller 8 instructs the power feeding device 20 to start power feeding in a case where the temperature inside the accommodation portion 10 falls to become lower than the lower limit of the predetermined temperature range after the power feeding controller 8 instructs the power feeding device 20 to stop power feeding. In this manner, the power feeding controller 8 instructs the power feeding device 20 to switch between starting and stopping power feeding to the vehicle V in accordance with a change in the temperature inside the accommodation portion 10. As a result, the power feeding controller 8 is capable of adjusting the temperature inside the accommodation portion 10 to a temperature range suitable for keeping the battery 73 warm using the heat generated from the battery 73 or the like when power is fed to the vehicle V. The power feeding controller 8 uses the upper limit (for example, 30° C.) of the temperature range as a reference in the case of power feeding stop and uses the lower limit (for example, 20° C.) of the temperature range as a reference in the case of power feeding start. In this manner, by the references in the cases of power feeding stop and power feeding start not being the same value, a situation in which a phenomenon in which power feeding stop and start are repeated within a short time (hunting) occurs is avoided.

The temperature range suitable for keeping the battery 73 warm is not limited to the example of the numerical range described above. For example, the temperature range suitable for keeping the battery 73 warm may be appropriately changed in view of the environment of use of the battery 73. For example, the temperature range suitable for keeping the battery 73 warm may be changed in accordance with the air temperature outside the accommodation portion 10. For example, in a case where the air temperature outside the accommodation portion 10 is as low as 0° C. or less, the temperature range suitable for keeping the battery 73 warm may be set to 10° C. or higher and 20° C. or lower. In this case, a temperature sensor acquiring the air temperature outside the accommodation portion 10 may be separately installed and the temperature range suitable for keeping the battery 73 warm may be adjusted in accordance with the detection result of the temperature sensor.

In such a case as well, a decline in the performance of the battery 73 can be suppressed as compared with a case where the vehicle V is placed outside the accommodation portion 10. Further, on condition that the temperature range suitable for keeping the battery 73 warm is set low in this manner, electric power that is required to raise the temperature to the temperature range (that is, electric power supplied from the power feeding device 20 to the battery 73 in order to raise the temperature inside the accommodation portion to the temperature range) can be suppressed. A temperature sensor measuring the air temperature outside the accommodation portion 10 may not be installed and, for example, the temperature range suitable for keeping the battery 73 warm may vary with the change of seasons. For example, in winter (determined to be within the period of December to March by referring to, for example, calendar information), a fall in the air temperature outside the accommodation portion 10 is predictable, and thus the temperature range suitable for keeping the battery 73 warm may be set as low as 10° C. or higher and 20° C. or lower in the winter period.

Next, the configuration of the vehicle V will be described. As illustrated in FIG. 7, the vehicle V includes a charging unit 70, a vehicle control device 80, and a self-parking control device 90. The charging unit 70 wirelessly receives power transmitted from the power transmission coil unit 21 of the parking facility 2 when the vehicle V is stopped in the parking section P. The charging unit 70 has, for example, the power receiving coil unit 71, a power receiving circuit unit 72, and the battery 73.

As illustrated in FIG. 4B, the power receiving coil unit 71 is provided on, for example, the lower surface of the vehicle V. More specifically, the power receiving coil unit 71 is provided at the position that faces the power transmission coil unit 21 in the vertical direction when the vehicle V has stopped in the parking section P. The power receiving coil unit 71 wirelessly receives power from the power transmission coil unit 21. The power receiving coil unit 71 includes, for example, a circular coil and a capacitor and an inductor for wireless power reception efficiency enhancement. However, the internal configuration of the power receiving coil unit 71 may be another configuration insofar as power can be wirelessly received from the power transmission coil unit 21. The power transmission coil unit 21 generates a magnetic field in a state of facing the power receiving coil unit 71 of the vehicle V. An electromotive force is generated in the power receiving coil unit 71 by interlinking the magnetic field generated by the power transmission coil unit 21 with the power receiving coil unit 71. As a result, the power receiving coil unit 71 is capable of wirelessly receiving power from the power transmission coil unit 21. The electric power generated in the power receiving coil unit 71 is input to the power receiving circuit unit 72.

The power receiving circuit unit 72 and the battery 73 are, for example, mounted at positions close to the lower surface of the vehicle V in order to lower the position of the center of gravity of the vehicle V and stabilize the travel of the vehicle V. The battery 73 is, for example, disposed at a position facing the upper part of the power receiving coil unit 71. The power receiving circuit unit 72 is electrically connected to the battery 73 and the power receiving coil unit 71 via a cable. The power receiving circuit unit 72 includes, for example, a rectifier circuit that converts AC power received by the power receiving coil unit 71 into DC and a DC-DC converter that converts a DC voltage into a voltage suitable for charging the battery 73. The output from the power receiving circuit unit 72 is input to the battery 73 to charge the battery 73. The battery 73 is used as, for example, an electric power source to such a component as an electric motor mounted in the vehicle V. The mounting positions of the power receiving circuit unit 72 and the battery 73 in the vehicle V are not particularly limited.

Referring back to FIG. 7, the vehicle control device 80 controls, for example, charging of the battery 73 of the vehicle V. The vehicle control device 80 is configured as, for example, a computer including a communication unit 81 and an integrated controller 82. The communication unit 81 is a communication device that communicates with each unit of the vehicle V and the parking facility control device 3. The communication unit 81 includes a wireless communication device and performs wireless communication with the communication unit 4 of the parking facility control device 3. The communication unit 81 may perform wired communication or wireless communication with the charging unit 70 and the self-parking control device 90.

The integrated controller 82 is a processing unit that executes various types of control such as charging of the battery 73. The integrated controller 82 is constituted by, for example, an electronic control unit including a microprocessor, a memory, a storage device storing an operation-defining program, and so on. The integrated controller 82 implements various functions by, for example, loading the program stored in the storage device into the memory and executing the program loaded into the memory with the microprocessor.

The integrated controller 82 has, for example, a charging controller 83 and an information processing unit 84 as functional configurations. In a case where the vehicle V has arrived in the stop section PX for the battery 73 to be charged, the information processing unit 84 transmits an entry request signal to the parking facility control device 3. The entry request signal is a signal requesting entry of the vehicle V into the parking section P. In transmitting the entry request signal, the information processing unit 84 transmits the ID of the vehicle V for identifying the vehicle V together with a power feeding request signal. The ID of the vehicle V is identification information with which the individual vehicle V can be identified, and each vehicle V has a different ID. A mobile phone number, an IP address in Internet communication, or identification information equivalent thereto can be used as the ID of the vehicle V. By referring to the ID of the vehicle V, the parking facility control device 3 is capable of identifying the vehicle V that is a communication target among the plurality of vehicles V and performing wireless communication.

In a case where the vehicle V has arrived in the parking section P under the guidance of the parking facility control device 3, the information processing unit 84 transmits an entry end signal to the parking facility control device 3. The entry end signal is a signal indicating that entry of the vehicle V into the parking section P has ended. In transmitting the entry end signal, the information processing unit 84 also transmits the ID of the vehicle V together. As a result, the parking facility control device 3 is capable of identifying the vehicle V that has transmitted the entry end signal. The information processing unit 84 transmits battery information indicating the charging rate of the battery 73 to the parking facility control device 3 in response to a request from the parking facility control device 3. The information processing unit 84 is capable of generating the battery information by, for example, monitoring the state of charge of the battery 73.

The charging controller 83 controls the charging unit 70 such that power is received from the power transmission coil unit 21 by the power receiving coil unit 71 and electric power converted into an appropriate voltage by the power receiving circuit unit 72 is supplied to the battery 73. The charging controller 83 may determine whether or not charging is complete by monitoring the state of charge of the battery 73. In this case, the charging controller 83 may transmit a charging completion signal indicating that charging of the battery 73 is complete to the parking facility control device 3 in a case where charging of the battery 73 is complete, such as the battery 73 being fully charged.

The self-parking control device 90 is a control device for self-parking of the vehicle V. For example, the self-parking control device 90 causes the vehicle V to self-travel by recognizing an external situation based on the detection result of a sensor detecting a situation outside the vehicle V (camera, light detection and ranging (LiDAR), or the like) and controlling, for example, the steering mechanism and the drive motor of the vehicle V. Various well-known devices can be used as self-driving devices.

In the present embodiment, the self-parking control device 90 has the camera 91 that images the space in front of the vehicle V. The self-parking control device 90 is capable of recognizing the situation ahead based on an image captured by the camera 91 and causing the vehicle V to self-travel based on the recognition result. The self-parking control device 90 causes the vehicle V to self-travel between the stop section PX and the parking section P based on the entry permission signal or the exit permission signal transmitted from the parking facility control device 3. Specifically, the self-parking control device 90 recognizes the parking section P or the stop section PX based on a captured image captured by the camera 91. Then, the self-parking control device 90 causes the vehicle V to self-travel to the recognized parking section P or stop section PX, which is a target position.

Next, heat generated during power feeding to the vehicle V in the accommodation portion 10 will be described. When the power feeding device 20 performs power feeding to the vehicle V, the power transmission coil unit 21, the power transmission circuit unit 22, and the cable 23 illustrated in FIG. 4A generate heat. The power transmission coil unit 21, the power transmission circuit unit 22, and the cable 23 are provided at low positions in the accommodation portion 10 or on the floor surface 11. Also in the vehicle V, the power receiving coil unit 71, the power receiving circuit unit 72, and the battery 73 illustrated in FIG. 4B generate heat when power is fed from the power feeding device 20. The power receiving coil unit 71 is provided on the lower surface of the vehicle V and, in many cases, the power receiving circuit unit 72 and the battery 73 are also provided at low positions of the vehicle V. Therefore, the cold air near the floor surface 11 of the accommodation portion 10 is warmed by the heat generation of the power transmission coil unit 21, the power transmission circuit unit 22, the cable 23, the power receiving coil unit 71, the power receiving circuit unit 72, and the battery 73. Then, the warmed air rises by convection in the accommodation portion 10. In the present embodiment, the door portion 19 is in a closed state when power is fed to the vehicle V. Suppressed as a result is the warmed air (heat) in the accommodation portion 10 flowing out of the accommodation portion 10 when power is fed to the vehicle V.

Depending on the vehicle V, the air warmed by the power receiving coil unit 71, the power receiving circuit unit 72, and the battery 73 may be forcibly discharged out of the vehicle by a fan. Even in this case, the warmed air discharged out of the vehicle rises by convection in the accommodation portion 10. Further, depending on the vehicle V, the heat generated by the power receiving coil unit 71, the power receiving circuit unit 72, and the battery 73 may be absorbed by a refrigerant such as water and the heat absorbed by the refrigerant may be radiated by a radiator facing the outside of the vehicle. Even in this case, the air in the accommodation portion 10 is warmed by heat radiation performed by the radiator and the warmed air rises by convection in the accommodation portion 10.

<Processing Executed by Power Feeding System>

Next, the flow of processing executed by the parking facility control device 3 will be described. In the following description, the processing executed by the parking facility control device 3 will be divided into the three processes: entry processing, power feeding processing, and exit processing, then described. The entry processing is processing to cause the vehicle V that is stopped in the stop section PX to enter the parking section P. The power feeding processing is processing for power feeding to the vehicle V that has arrived in the parking section P. The exit processing is processing to cause the vehicle V that is stopped in the parking section P to exit to the stop section PX.

The parking facility control device 3 executes the entry processing when receiving the entry request signal from the vehicle V and executes the exit processing when receiving the exit request signal from the vehicle V. The parking facility control device 3 does not simultaneously execute the entry processing and the exit processing. The parking facility control device 3 executes the entry processing and the exit processing at different timings. Meanwhile, the parking facility control device 3 executes the power feeding processing independently of the entry processing and the exit processing. Therefore, the power feeding processing can be executed simultaneously (in parallel) with the entry processing and the exit processing.

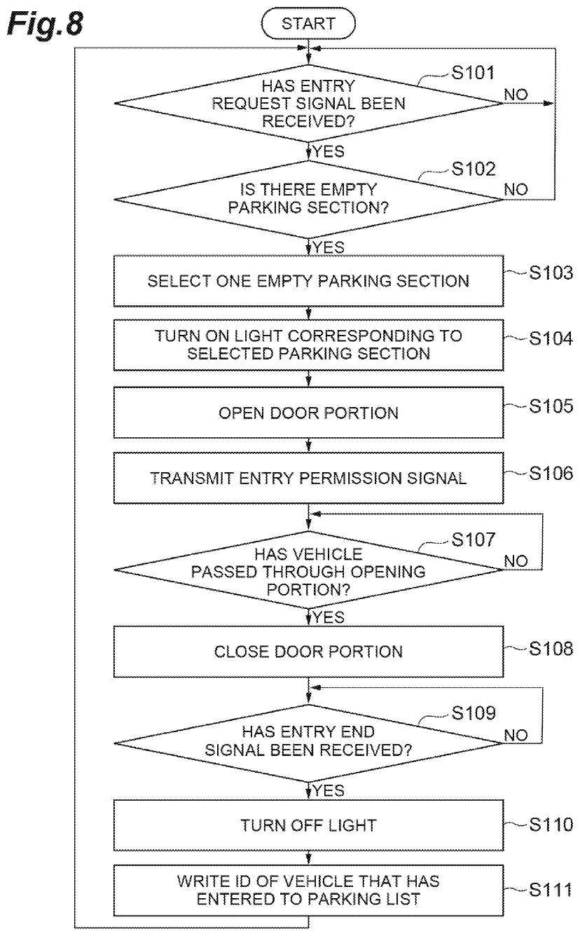

First, the entry processing will be described using the flowchart of FIG. 8. As illustrated in FIG. 8, the parking management unit 6 determines whether or not the entry request signal has been received from the vehicle V (step S101). In a case where the parking management unit 6 determines that the entry request signal has not been received (step S101: No), the parking management unit 6 repeatedly executes step S101 until the entry request signal is received. Meanwhile, in a case where the parking management unit 6 determines that the entry request signal has been received (step S101: YES), the parking management unit 6 determines whether or not there is an empty parking section P (step S102). In a case where the parking management unit 6 determines that there is no empty parking section P (step S102: No), the parking management unit 6 transmits the no-entry signal to the vehicle V. In this case, the parking management unit 6 returns to step S101 again.

Meanwhile, in a case where the parking management unit 6 determines that there is an empty parking section P (step S102: Yes), the parking management unit 6 selects one empty parking section P (step S103). In this case, the guidance controller 7 turns on only the light 30 that corresponds to the parking section P selected by the parking management unit 6 (step S104). Next, the guidance controller 7 opens the door portion 19 of the accommodation portion 10 (step S105). Next, the guidance controller 7 transmits the entry permission signal for permitting entry into the selected parking section P to the vehicle V that is stopped in the stop section PX (step S106). As a result, the vehicle V is capable of self-traveling to the selected parking section P indicated by the two section boundary lines L1 using the two section boundary lines L1 illuminated by the light 30 as marks.

Next, the guidance controller 7 determines whether or not the vehicle V has passed through the opening portion 18 of the accommodation portion 10 (step S107). In a case where the guidance controller 7 determines that the vehicle V has not passed through the opening portion 18 (step S107: No), the guidance controller 7 repeatedly executes step S107 until the vehicle V passes through the opening portion 18. Meanwhile, in a case where it is determined that the vehicle V has passed through the opening portion 18 (step S107: Yes), the guidance controller 7 closes the door portion 19 of the accommodation portion 10 (step S108). Next, the guidance controller 7 determines whether or not the entry end signal has been received from the vehicle V (step S109). In a case where the guidance controller 7 determines that the entry end signal has not been received (step S109: NO), the guidance controller 7 repeatedly executes step S109 until the entry end signal is received.

Meanwhile, in a case where the guidance controller 7 determines that the entry end signal has been received (step S109: Yes), the guidance controller 7 turns off the light 30 that corresponds to the selected parking section P (step S110). Next, the parking management unit 6 writes the ID of the vehicle V that has entered the selected parking section P to the storage field in the parking list PL that corresponds to the selected parking section P (step S111). The vehicle V is guided to the selected parking section P by the entry processing described above, and preparations for power feeding to the vehicle V are completed. After the end of step S111, the entry processing is restarted from step S101 in a predetermined time.

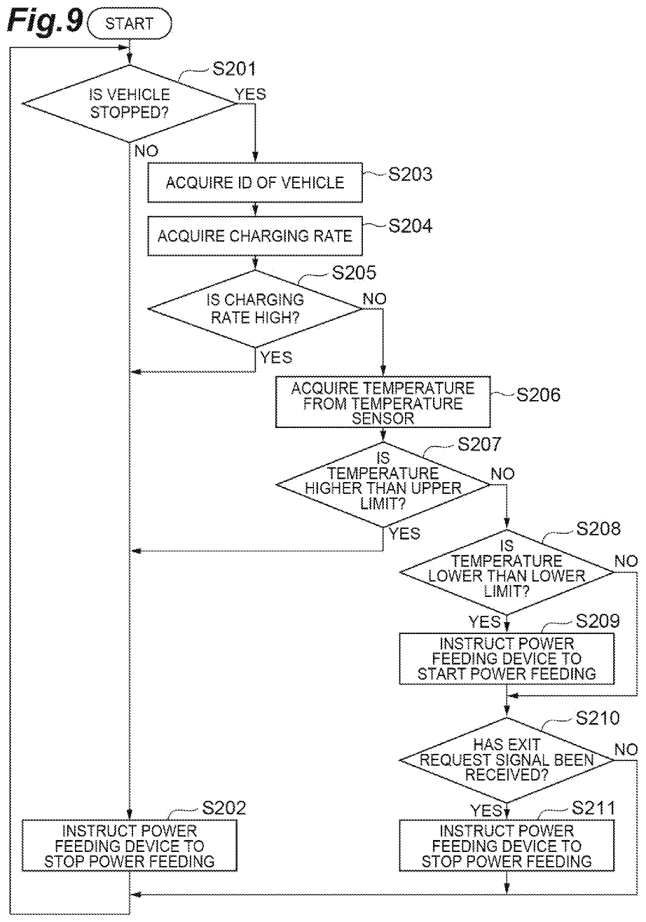

Next, the power feeding processing will be described using the flowchart of FIG. 9. The power feeding controller 8 repeatedly executes the power feeding processing illustrated in FIG. 9 with respect to the parking section P where the power feeding device 20 is installed.

First, the power feeding controller 8 determines whether or not the vehicle V is stopped in the parking section P where the power feeding device 20 is installed (step S201). In a case where the power feeding controller 8 determines that the vehicle V is not stopped in the parking section P where the power feeding device 20 is installed (step S201: No), the power feeding controller 8 instructs the power feeding device 20 of the parking section P to stop power feeding to the vehicle V (step S202). At this time, power feeding to the vehicle V is not performed on condition that the power feeding device 20 is in a state of feeding no power to the vehicle V. Meanwhile, in a case where the power feeding controller 8 determines that the vehicle V is stopped in the parking section P where the power feeding device 20 is installed (step S201: Yes), the power feeding controller 8 acquires the ID of the vehicle V stopped in the parking section P (step S203). Further, the power feeding controller 8 acquires the charging rate of the battery 73 of the vehicle V identified by the acquired ID (step S204).

Next, the power feeding controller 8 determines whether or not the acquired charging rate of the battery 73 is higher than the predetermined threshold (for example, 95%) (step S205). In a case where the power feeding controller 8 determines that the charging rate of the battery 73 is higher than the predetermined threshold (step S205: Yes), the power feeding controller 8 instructs the power feeding device 20 to stop power feeding (step S202). At this time, power feeding to the vehicle V is not performed on condition that the power feeding device 20 is in a state of feeding no power to the vehicle V. Meanwhile, in a case the power feeding controller 8 determines that the charging rate of the battery 73 is not higher than the predetermined threshold (step S205: No), the power feeding controller 8 acquires the temperature detected by the temperature sensor 60 (step S206). Next, the power feeding controller 8 determines whether or not the acquired temperature is higher than the upper limit (for example, 30° C.) of the predetermined temperature range determined in advance (step S207). As described above, the predetermined temperature range is a temperature range suitable for keeping the battery 73 warm and may be set to, for example, 20° C. or higher and 30° C. or lower.

In a case where the power feeding controller 8 determines that the acquired temperature is higher than the upper limit of the predetermined temperature range (step S207: Yes), the power feeding controller 8 instructs the power feeding device 20 to stop power feeding (step S202). At this time, power feeding to the vehicle V is not performed on condition that the power feeding device 20 is in a state of feeding no power to the vehicle V. Meanwhile, in a case where the power feeding controller 8 determines that the acquired temperature is not higher than the upper limit of the predetermined temperature range (step S207: No), the power feeding controller 8 determines whether or not the acquired temperature is lower than the lower limit (for example, 20° C.) of the predetermined temperature range (step S208).

In a case where the power feeding controller 8 determines that the acquired temperature is lower than the lower limit of the predetermined temperature range (step S208: Yes), the power feeding controller 8 instructs the power feeding device 20 to start power feeding (step S209). At this time, power feeding to the vehicle V continues on condition that the power feeding device 20 is in a state of feeding power to the vehicle V. Meanwhile, in a case where the power feeding controller 8 determines that the acquired temperature is not lower than the lower limit of the predetermined temperature range (step S208: No), the power feeding controller 8 does not instruct the power feeding device 20 to start or stop power feeding. In this case, power feeding to the vehicle V continues on condition that the power feeding device 20 is in a state of feeding power to the vehicle V, and power feeding to the vehicle V is not performed on condition that the power feeding device 20 is in a state of feeding no power to the vehicle V.

Next, the power feeding controller 8 determines whether or not the exit request signal has been received (step S210). In a case where the power feeding controller 8 determines that the exit request signal has been received (step S210: Yes), the power feeding controller 8 instructs the power feeding device 20 to stop power feeding (step S211). At this time, power feeding to the vehicle V is not performed on condition that the power feeding device 20 is in a state of feeding no power to the vehicle V. Meanwhile, in a case where the power feeding controller 8 determines that the exit request signal has not been received (step S210: No), the power feeding controller 8 does not instruct the power feeding device 20 to start or stop power feeding. In this case, power feeding to the vehicle V continues on condition that the power feeding device 20 is in a state of feeding power to the vehicle V, and power feeding to the vehicle V is not performed on condition that the power feeding device 20 is in a state of feeding no power to the vehicle V. After the end of step S202, step S210, or step S211, the power feeding processing is restarted from step S201 in a predetermined time.

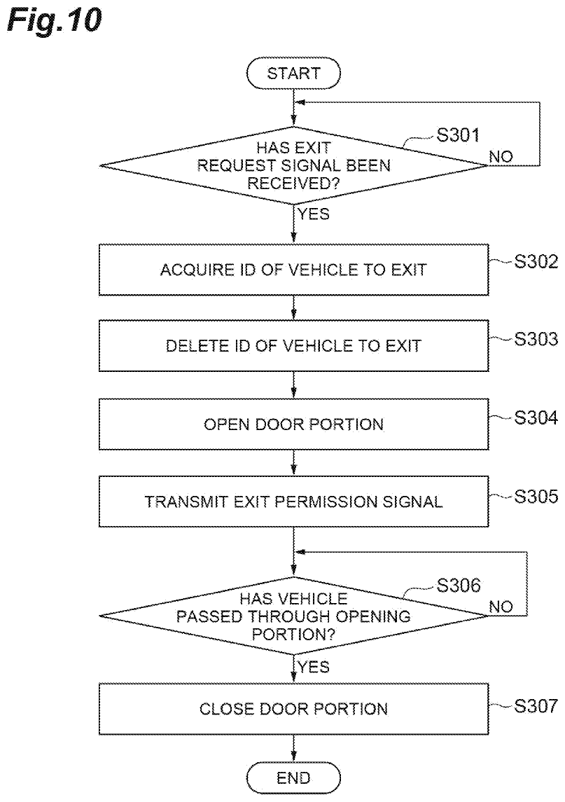

Next, the exit processing will be described using the flowchart of FIG. 10. First, the guidance controller 7 determines whether or not the exit request signal has been received (step S301). In a case where the guidance controller 7 determines that the exit request signal has not been received (step S301: No), the guidance controller 7 repeatedly executes step S301 until the exit request signal is received. Meanwhile, in a case where the guidance controller 7 determines that the exit request signal has been received (step S301: YES), the guidance controller 7 acquires the ID of the vehicle V to exit (step S302). Next, the parking management unit 6 deletes the ID of the vehicle V to exit from the storage field in the parking list PL in which the ID of the vehicle V to exit is stored and writes “empty” to the storage field (step S303).

Next, the guidance controller 7 opens the door portion 19 of the accommodation portion 10 (step S304). Next, the guidance controller 7 transmits the exit permission signal to the vehicle V to exit (step S305). As a result, the vehicle V to exit is capable of self-traveling to the stop section PX indicated by the two section boundary lines L2 using the two section boundary lines L2 outside the opening portion 18 as marks. Next, the guidance controller 7 determines whether or not the vehicle V has passed through the opening portion 18 of the accommodation portion 10 (step S306). In a case where the guidance controller 7 determines that the vehicle V has not passed through the opening portion 18 (step S306: No), the guidance controller 7 repeatedly executes step S306 until the vehicle V passes through the opening portion 18. Meanwhile, in a case where the guidance controller 7 determines that the vehicle V has passed through the opening portion 18 (step S306: Yes), the guidance controller 7 closes the door portion 19 of the accommodation portion 10 (step S307). Then, the guidance controller 7 ends the exit processing sequence.

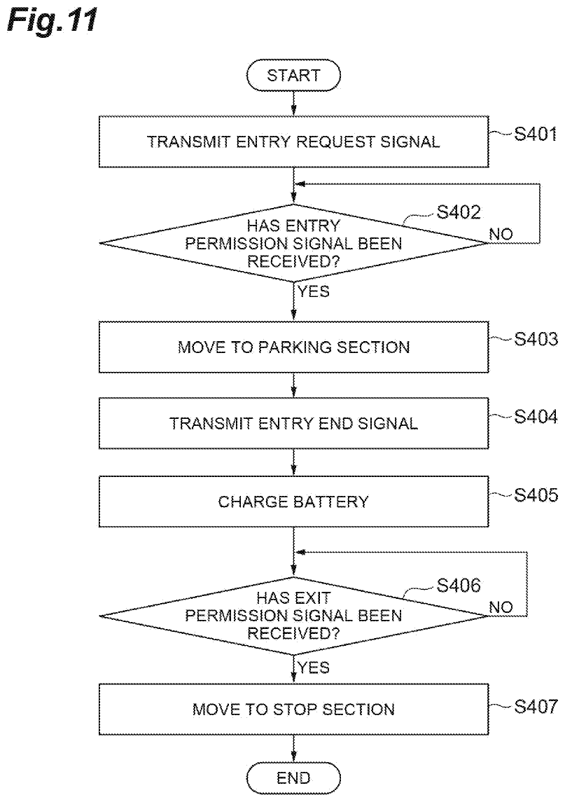

Next, the flow of charging processing executed by the vehicle control device 80 will be described using the flowchart of FIG. 11. First, upon the vehicle V arriving in the stop section PX, the information processing unit 84 transmits the entry request signal to the parking facility control device 3 (step S401). At this time, the information processing unit 84 also transmits the ID of the vehicle V together with the entry request signal. Next, the information processing unit 84 determines whether or not the entry permission signal has been received from the parking facility control device 3 (step S402). In a case where the information processing unit 84 determines that the entry permission signal has not been received (S402: NO), the information processing unit 84 repeatedly executes step S402 until the entry permission signal is received. Meanwhile, in a case where the information processing unit 84 determines that the entry permission signal has been received by the information processing unit 84 (step S402: YES), the self-parking control device 90 causes the vehicle V to self-travel to the parking section P indicated by the two section boundary lines L1 based on an image captured by the camera 91 (step S403). Upon the vehicle V arriving in the parking section P, the information processing unit 84 transmits the entry end signal to the parking facility control device 3 (step S404).

Next, the charging controller 83 controls the charging unit 70 to charge the battery 73 (step S405). Specifically, the charging controller 83 controls the charging unit 70 such that power is received from the power transmission coil unit 21 by the power receiving coil unit 71 and power converted into an appropriate voltage by the power receiving circuit unit 72 is supplied to the battery 73 (step S405). Next, the information processing unit 84 determines whether or not the exit permission signal has been received (step S406). In a case where the information processing unit 84 determines that the exit permission signal has not been received (step S406: NO), the information processing unit 84 repeatedly executes step S406 until the exit permission signal is received. Meanwhile, in a case where the information processing unit 84 determines that the exit permission signal has been received by the information processing unit 84 (step S406: YES), the self-parking control device 90 causes the vehicle V to self-travel to the stop section PX based on an image captured by the camera 91 (step S407). Then, the vehicle V ends the charging processing sequence.

### Actions and Effects

Actions and effects of the power feeding system 1 according to the present embodiment described above will be described below. In the power feeding system 1 according to the present embodiment, the accommodation portion 10 accommodating the vehicle V is configured to include a heat insulating material. As a result, the heat (air warmed by heat) that is generated during power feeding to the battery 73 of the vehicle V can be retained in the accommodation portion 10. Further, in the power feeding system 1, power feeding to the vehicle V is controlled such that the temperature (air temperature) inside the accommodation portion 10 is within a temperature range suitable for keeping the battery 73 warm. By controlling power feeding to the vehicle V, it is possible to cause a change in the amount of heat in the accommodation portion 10 (amount of heat retained by the heat capacity of air) entailed by the heat generation of the battery 73 or the like, and thus the temperature inside the accommodation portion 10 can be adjusted to the temperature range suitable for keeping the battery 73 warm using the change in the amount of heat. With such a configuration that adjusts the temperature inside the accommodation portion 10 using heat generated during power feeding, it is possible to appropriately keep the battery 73 of the vehicle V warm with simple equipment without requiring separate equipment for adjusting the temperature inside the accommodation portion 10. As a result, the battery 73 can be used for a long period of time, and an increase in resources and energy required for manufacturing and discarding the battery 73 can be suppressed. Further, equipment such as air-conditioning equipment is not required, and thus energy supply for driving the equipment becomes unnecessary and energy can be saved.

Further, in the present embodiment, the entire process from the vehicle V entering the accommodation portion 10 to the vehicle V exiting the accommodation portion 10 after power feeding from the power feeding device 20 can be performed in an unmanned and autonomous manner. As a result, the accommodation portion 10 does not have to be provided with a separate opening portion for a person to enter and exit, and thus it is possible to suppress a situation in which the air warmed in the accommodation portion 10 is released to the outside through the opening portion, and the thermal insulation of the accommodation portion 10 can be further enhanced. As a result, the heat generated during power feeding to the vehicle V can be efficiently used and the battery 73 can be kept warm with less energy. In a case where the vehicle V is an electric car equipped with an electric motor as a power source, ambient oxygen does not have to be taken in and no exhaust gas is emitted, unlike in the case of an internal combustion engine vehicle, and thus ventilation between the inside and the outside of the accommodation portion 10 does not necessarily have to be performed. Therefore, the accommodation portion 10 is capable of exhibiting high thermal insulation with the door portion 19 closed.

In the present embodiment, the power feeding controller 8 instructs the power feeding device 20 to stop power feeding to vehicle V in a case where the temperature detected by temperature sensor 60 is higher than the upper limit of the temperature range. As a result, a rise in temperature in the accommodation portion 10 attributable to the heat generated during power feeding to the vehicle V can be suppressed. As a result, the temperature inside the accommodation portion 10 can be adjusted so as not to exceed the upper limit of the temperature range suitable for keeping the battery 73 warm. Further, the energy that is supplied from the power feeding device 20 to the battery 73 can be saved by stopping power feeding to the vehicle V.

In the present embodiment, the power feeding controller 8 instructs the power feeding device 20 to start power feeding to the vehicle V in a case where the temperature detected by the temperature sensor 60 is lower than the lower limit of the temperature range. As a result, a rise in temperature in the accommodation portion 10 attributable to the heat generated during power feeding to the vehicle V can be promoted. As a result, the temperature inside the accommodation portion 10 can be adjusted so as not to fall below the lower limit of the temperature range suitable for keeping the battery 73 warm.

In the present embodiment, the temperature sensor 60 in the accommodation portion 10 is installed at a position closer to the ceiling wall 13 of the accommodation portion 10 than to the floor surface 11 of the accommodation portion 10. In this case, a situation in which the temperature sensor 60 hinders movement of the vehicle V can be suppressed as compared with a case where the temperature sensor 60 is installed on the floor surface 11 of the accommodation portion 10. The air warmed by the heat that is generated from the battery 73 during power feeding is likely to rise by convection and stay near the ceiling wall 13, and thus the temperature detected by the temperature sensor 60 installed at the position close to the ceiling wall 13 can be appropriately used as the environmental temperature of the battery 73.

In the present embodiment, the power feeding device 20 includes the power transmission coil unit 21 installed on the floor surface 11 of the accommodation portion 10 and wirelessly transmitting power to the battery 73. As a result, the heat generated from the power transmission coil unit 21 as well as the heat generated from the battery 73 during power feeding can be used to adjust the temperature inside the accommodation portion 10.

In the present embodiment, the power transmission coil unit 21 may be exposed in the accommodation portion 10 from the floor surface 11. In this case, the heat generated from the power transmission coil unit 21 during power feeding is likely to stay in the accommodation portion 10, and thus the temperature inside the accommodation portion 10 can be efficiently adjusted using the heat generated from the power transmission coil unit 21.

In the present embodiment, the power transmission circuit unit 22 in the accommodation portion 10 is installed at a position closer to the floor surface 11 than to the ceiling wall 13 of the accommodation portion 10. In this case, the heat generated from the power transmission circuit unit 22 as well as the heat generated from the battery 73 and the power transmission coil unit 21 during power feeding can be used to adjust the temperature inside the accommodation portion 10. Further, by installing the power transmission circuit unit 22 at the position close to the floor surface 11 of the accommodation portion 10, the temperature inside the accommodation portion 10 can be efficiently adjusted using the heat generated from the power transmission circuit unit 22.

In the present embodiment, the power feeding devices 20A, 20B, and 20C are installed so as to be separated in the direction along the floor surface 11 of the accommodation portion 10. In this case, the plurality of vehicles V can be simultaneously fed with power using the power feeding devices 20A, 20B, and 20C. As a result, the temperature inside the accommodation portion 10 can be efficiently adjusted using the heat generated during power feeding to the battery 73 of each vehicle V. Further, by power feeding to the plurality of vehicles V in the accommodation portion 10 being possible as described above, it is possible to increase the possibility that the vehicle V that requires power feeding is present in the accommodation portion 10. As a result, it is possible to continuously adjust the temperature inside the accommodation portion 10 using the heat generated during power feeding.

In the present embodiment, the temperature sensor 60 is positioned between the power feeding device 20B and the power feeding device 20C in the direction D1. As a result, in the accommodation portion 10, it is possible to bring the temperature sensor 60 close to a position close to the battery 73 of the vehicle V while disposing the temperature sensor 60 at a position that does not hinder movement of the vehicle V. As a result, the temperature detected by the temperature sensor 60 can be more appropriately used as the environmental temperature of the battery 73.

In the present embodiment, the guidance controller 7 controls the door portion 19 to be opened when the vehicle V enters the accommodation portion 10 from the opening portion 18. The guidance controller 7 controls the door portion 19 to be closed when the passage sensor 40 has detected that the vehicle V has passed through the opening portion 18. As a result, the door portion 19 can be closed before the vehicle V arrives in the parking section P of the accommodation portion 10. As a result, the time during which the opening portion 18 of the accommodation portion 10 is opened can be minimized, and a situation in which the air warmed in the accommodation portion 10 is released to the outside can be suppressed.

The power feeding system of the present disclosure is not limited to the embodiment described above. Specific aspects of the power feeding system of the present disclosure may be appropriately changed without departing from the scope of the claims.

### Modification Example 1

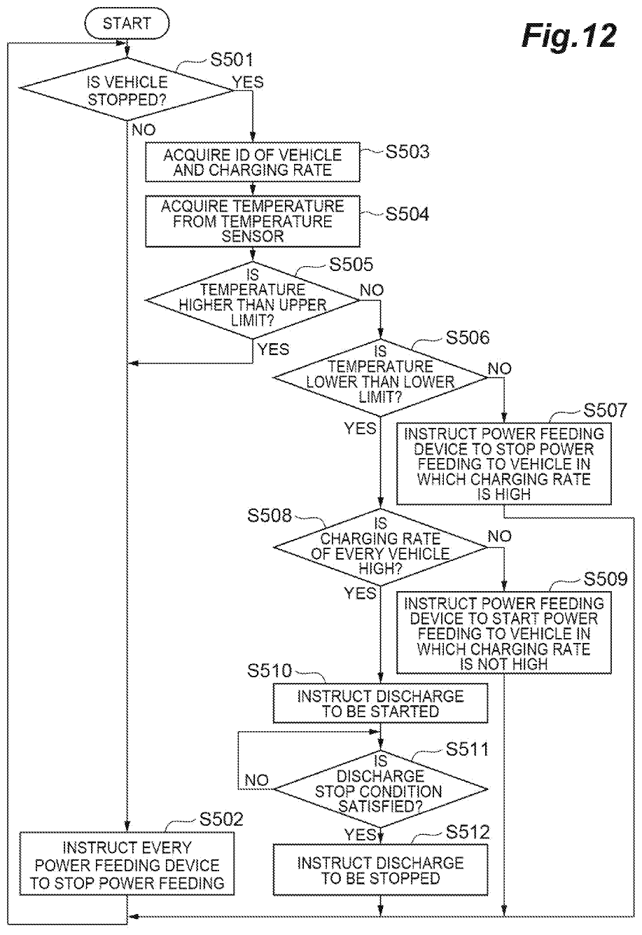

For example, the power feeding processing executed by the power feeding controller 8 is not limited to the power feeding processing illustrated in FIG. 9 described above. The power feeding controller 8 may execute, for example, the power feeding processing illustrated in FIG. 12. In a case where the charging rate of the battery 73 of the vehicle V is higher than the predetermined threshold (for example, 95%), the temperature inside the accommodation portion 10 cannot be raised using the heat generated during power feeding to the battery 73 even with the temperature inside the accommodation portion 10 lower than the lower limit (for example, 20° C.) of the predetermined temperature range. Therefore, in the example illustrated in FIG. 12, the power feeding controller 8 controls the battery 73 to be discharged in a case where the charging rate of the battery 73 of the vehicle V is higher than the predetermined threshold and the temperature inside the accommodation portion 10 is lower than the lower limit of the predetermined temperature range.

Even when the battery 73 is discharged, it is possible to promote a rise in temperature in the accommodation portion 10 by an increase in the amount of heat in the accommodation portion 10 entailed by the heat generation of the battery 73 or the like. Therefore, the power feeding controller 8 is capable of adjusting the temperature inside the accommodation portion 10 by instructing discharge of the battery 73 to be started or stopped. In the example illustrated in FIG. 12, the power feeding controller 8 performs control such that the battery 73 of at least one vehicle V is discharged in a case where the charging rates of the batteries 73 of all the vehicles V stopped in the parking sections P where the power feeding device 20 is installed are higher than the predetermined threshold. In this configuration, at least one power feeding device 20 and the charging unit 70 of the vehicle V that enters the parking section P where the power feeding device 20 is installed are capable of bidirectional power feeding between the power feeding device 20 and the charging unit 70 in a case where the power feeding controller 8 executes the power feeding processing illustrated in FIG. 12. In other words, the power feeding device 20 and the charging unit 70 are configured to be capable of power feeding from the power feeding device 20 to the charging unit 70 and discharge from the charging unit 70 to the power feeding device 20.

In the power feeding processing illustrated in FIG. 12, the power feeding controller 8 first determines whether or not the vehicle V is stopped in any of the parking sections P where the power feeding device 20 is installed (step S501). In a case where the power feeding controller 8 determines that the vehicle V is not stopped in any parking section P where the power feeding device 20 is installed, that is, in a case where the power feeding controller 8 determines that every parking section P where the power feeding device 20 is installed is empty (step S501: No), the power feeding controller 8 instructs every power feeding device 20 to stop power feeding to the vehicle V (step S502). At this time, power feeding to the vehicle V is not performed on condition that every power feeding device 20 is in a state of feeding no power to the vehicle V. Meanwhile, in a case where the power feeding controller 8 determines that the vehicle V is stopped in any of the parking sections P where the power feeding device 20 is installed (step S501: Yes), the power feeding controller 8 acquires the ID of the vehicle V stopped in the parking section P and the charging rate of the battery 73 (step S503). The power feeding controller 8 acquires the detection result (that is, the temperature inside the accommodation portion 10) from the temperature sensor 60 (step S504).

Next, the power feeding controller 8 determines whether or not the acquired temperature is higher than the upper limit (for example, 30° C.) of the predetermined temperature range determined in advance (step S505). As described above, the predetermined temperature range is the temperature range suitable for keeping the battery 73 warm and is set to, for example, 20° C. or higher and 30° C. or lower. In a case where the power feeding controller 8 determines that the acquired temperature is higher than the upper limit of the predetermined temperature range (step S505: Yes), the power feeding controller 8 instructs every power feeding device 20 to stop power feeding (step S502). At this time, power feeding to the vehicle V is not performed on condition that every power feeding device 20 is in a state of feeding no power to the vehicle V. Meanwhile, in a case where the power feeding controller 8 determines that the acquired temperature is not higher than the upper limit of the predetermined temperature range (step S505: No), the power feeding controller 8 determines whether or not the acquired temperature is lower than the lower limit (for example, 20° C.) of the predetermined temperature range (step S506).

In a case where the power feeding controller 8 determines that the acquired temperature is not lower than the lower limit of the predetermined temperature range (step S506: No), the power feeding controller 8 instructs the power feeding device 20 to stop power feeding to the vehicle V in which the charging rate of the battery 73 is higher than the predetermined threshold (for example, 95%) (step S507). Specifically, the power feeding controller 8 determines whether or not the charging rate of the battery 73 of the vehicle V stopped in each parking section P is high. Then, the power feeding controller 8 instructs the power feeding device 20 to stop power feeding to the vehicle V in which the determined charging rate of the battery 73 is higher than the predetermined threshold. Meanwhile, the power feeding controller 8 does not instruct the power feeding device 20 to, for example, start or stop power feeding to the vehicle V in which the determined charging rate of the battery 73 is not higher than the predetermined threshold. In this case, power feeding to the vehicle V continues on condition that the power feeding device 20 is in a state of feeding power to the vehicle V, and power feeding to the vehicle V is not performed on condition that the power feeding device 20 is in a state of feeding no power to the vehicle V.

In a case where it is determined that the acquired temperature is lower than the lower limit of the predetermined temperature range (step S506: Yes), the power feeding controller 8 determines whether or not the charging rates of the batteries 73 of all the vehicles V stopped in the parking sections P are higher than the predetermined threshold (for example, 95%) (step S508). In a case where the power feeding controller 8 determines that the charging rates of the batteries 73 of all the vehicles V are not higher than the predetermined threshold, that is, in a case where the power feeding controller 8 determines the charging rate of the battery 73 of any of the vehicles V is not higher than the predetermined threshold) (step S508: No), the power feeding controller 8 instructs the power feeding device 20 to start power feeding to the vehicle V in which the determined charging rate of the battery 73 is not higher than the predetermined threshold (step S509). At this time, power feeding to the vehicle V continues on condition that the power feeding device 20 is in a state of feeding power to the vehicle V.

In a case where the power feeding controller 8 determines that the charging rates of the batteries 73 of all the vehicles V are higher than the predetermined threshold (step S508: Yes), the power feeding controller 8 starts discharge of the battery 73 of at least one vehicle V (step S510). Specifically, the power feeding controller 8 outputs, to the power feeding device 20 and the vehicle V, a signal instructing discharge of the battery 73 to be started. Next, the power feeding controller 8 determines whether or not a discharge stop condition is satisfied (step S511). The discharge stop condition may be, for example, a case where the temperature acquired from the temperature sensor 60 is not lower than the lower limit (for example, 20° C.) of the predetermined temperature range or a case where the charging rate of the battery 73 of the vehicle V during the discharge has become equal to or less than a predetermined value (for example, 80%). The discharge stop condition is not limited to the examples described above and may be changed as appropriate.

In a case where the power feeding controller 8 determines that the discharge stop condition is not satisfied (step S511: No), the power feeding controller 8 repeatedly executes step S511 until the discharge stop condition is satisfied. Meanwhile, in a case where the power feeding controller 8 determines that the discharge stop condition is satisfied (step S511: Yes), the power feeding controller 8 stops discharge of the battery 73 of the vehicle V (step S512). Specifically, the power feeding controller 8 outputs, to the power feeding device 20 and the vehicle V, a signal instructing discharge of the battery 73 to be stopped. After the end of step S502, step S507, step S509, or step S512, the power feeding processing illustrated in FIG. 12 is restarted from step S501 in a predetermined time. In this manner, the power feeding controller 8 repeatedly executes the processing illustrated in FIG. 12 with respect to every parking section P where the power feeding device 20 is installed. In the case of exit request signal reception during the repetition of the processing illustrated in FIG. 12, the power feeding controller 8 instructs the power feeding device 20 of the parking section P where the vehicle V to exit is stopped to stop power feeding. At this time, power feeding to the vehicle V is not performed on condition that the power feeding device 20 is in a state of feeding no power to the vehicle V. If the vehicle V to exit is in the process of discharge, the power feeding controller 8 instructs the power feeding device 20 of the parking section P where the vehicle V to exit is stopped to stop discharge.

To summarize the above-described processing, in a case where the temperature detected by the temperature sensor 60 is higher than the upper limit (for example, 30° C.) of the predetermined temperature range, the power feeding controller 8 instructs every power feeding device 20 to stop power feeding. In a case where the temperature detected by the temperature sensor 60 is not higher than the upper limit of the predetermined temperature range and the temperature is not lower than the lower limit (for example, 20° C.) of the predetermined temperature range, the power feeding controller 8 instructs the power feeding device 20 where the charging rate of the battery 73 is higher than the predetermined threshold (for example, 95%) to stop power feeding. Meanwhile, in a case where the temperature detected by the temperature sensor 60 is lower than the lower limit of the predetermined temperature range and the charging rate of the battery 73 of every vehicle V is not higher than the predetermined threshold, the power feeding controller 8 instructs the power feeding device 20 where the charging rate of the battery 73 is not higher than the predetermined threshold to start power feeding.

Further, in a case where the temperature detected by the temperature sensor 60 is lower than the lower limit of the predetermined temperature range and the charging rate of the battery 73 of every vehicle V is higher than the predetermined threshold, the power feeding controller 8 instructs the power feeding device 20 to start discharge of the battery 73 of at least one vehicle V. Then, the power feeding controller 8 instructs the power feeding device 20 to stop discharge of the battery 73 in a case where the discharge stop condition as described above is satisfied. Therefore, in the power feeding processing illustrated in FIG. 12, even in a case where the charging rate of the battery 73 of every vehicle V is high, the power feeding controller 8 is capable of promoting a rise in temperature in the accommodation portion 10 using the heat generated from the battery 73 of the vehicle V or the like during discharge by executing the processing of discharge of the battery 73. As a result, the temperature inside the accommodation portion 10 can be more reliably adjusted so as not to fall below the lower limit of the temperature range suitable for keeping the battery 73 warm. The electric power discharged from the battery 73 may be used for electrical equipment in an external building or sold.

### Modification Example 2

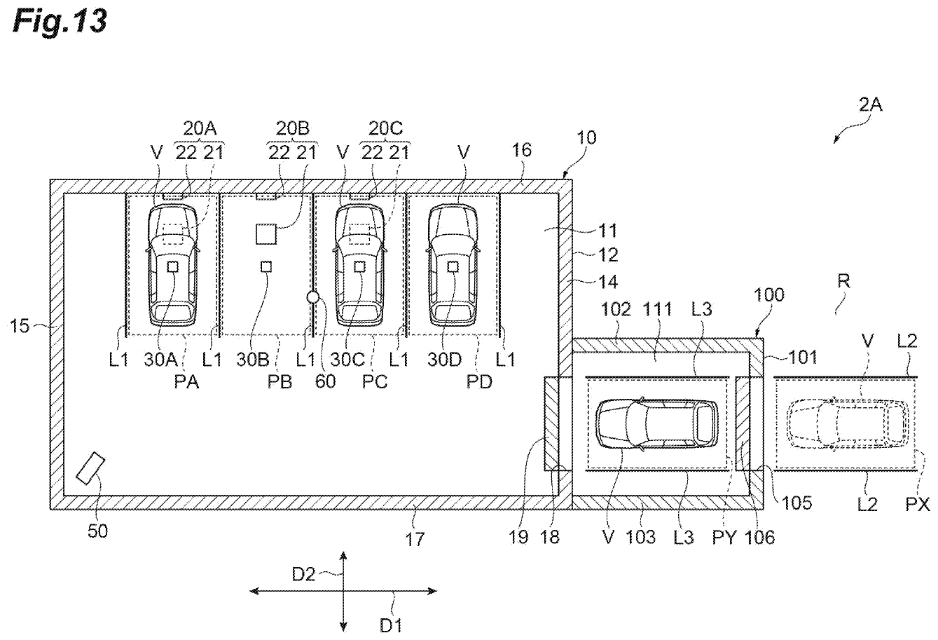

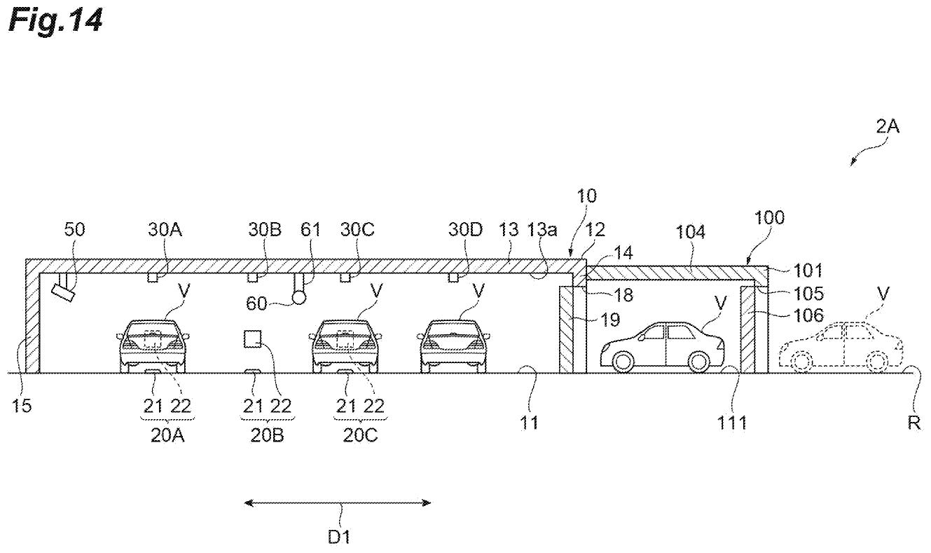

The configuration of the parking facility 2 is not limited to the example illustrated in FIGS. 1 and 2 described above. For example, a parking facility 2A illustrated in FIGS. 13 and 14 may be used. In the example illustrated in FIGS. 13 and 14, the parking facility 2A has a double-door structure. In this case, the parking facility 2A has, outside the opening portion 18 of the accommodation portion 10, a temporary accommodation portion 100 that temporarily accommodates the vehicle V heading for the accommodation portion 10. The temporary accommodation portion 100 is, for example, capable of accommodating one vehicle V. The temporary accommodation portion 100 is constituted by, for example, a floor surface 111 adjacent to the floor surface 11 via the opening portion 18, a side wall 101 facing the side wall 14 of the accommodation portion 10 with an interval in the direction D1, two side walls 102 and 103 connecting the side wall 14 and the side wall 101 in the direction D1, and a ceiling wall 104 facing the floor surface 111 in the vertical direction.

The inside of the temporary accommodation portion 100 communicates with the inside of the accommodation portion 10 via the opening portion 18, and the floor surface 111 of the temporary accommodation portion 100 and the floor surface 11 of the accommodation portion 10 are smoothly connected via the opening portion 18. The side wall 101 of the temporary accommodation portion 100 is formed with an opening portion 105 for the vehicle V to enter or exit the accommodation portion 10. As illustrated in FIG. 13, the opening portion 105 is, for example, formed at a position corresponding to the opening portion 18 of the accommodation portion 10. The opening portion 105 has a size at which the vehicle V is capable of passing and allows the inside and the outside of the temporary accommodation portion 100 to communicate with each other. The floor surface 111 of the temporary accommodation portion 100 and the external road surface R are smoothly connected via the opening portion 105.

The opening portion 105 is provided with a door portion 106 for opening and closing the opening portion 105. The door portion 106 is, for example, an electric door portion that can be opened and closed based on instructions from the parking facility control device 3 and has the same configuration as the door portion 19. The door portion 19 and the door portion 106 are configured as double doors. The door portion 19 is an inside door portion provided at the connection part between the accommodation portion 10 and the temporary accommodation portion 100, and the door portion 106 is an outside door portion facing the outside of the accommodation portion 10 and the temporary accommodation portion 100. In a case where the door portion 19 and the door portion 106 are in a closed state, the opening portion 18 and the opening portion 105 are closed, and each of the inside of the accommodation portion 10 and the inside of the temporary accommodation portion 100 is blocked.

One temporary standby section PY is preset on the floor surface 111 of the temporary accommodation portion 100. The temporary standby section PY is a section defining the position where the vehicle V that enters the accommodation portion 10 from the external stop section PX stands by temporarily. One vehicle V can stop in the temporary standby section PY. The temporary standby section PY is defined by two section boundary lines L3 provided on both sides in the direction D2. In other words, the temporary standby section PY is defined as the region that is sandwiched between the two section boundary lines L3. The two section boundary lines L3 are, for example, lines drawn in a different color from the floor surface 111 (for example, white lines).

The vehicle V is capable of extracting the two section boundary lines L3 from an image captured by the camera 91 and grasping the region that is sandwiched between the two extracted section boundary lines L3 as the temporary standby section PY. The temporary standby section PY is set such that the two section boundary lines L3 indicating the temporary standby section PY enter the imaging field of view of the camera 91 of the vehicle V that stops in the parking section P or the stop section PX. The temporary standby section PY may have the same color as the floor surface 111 (that is, have a uniform appearance with the floor surface 111) or may be painted in a different color from the floor surface 111 and the section boundary line L3. Although the temporary standby section PY in FIG. 13 is indicated by a dashed line in the interest of convenience, the dashed line does not have to be actually drawn on the floor surface 111.

In a case where the parking facility 2A illustrated in FIGS. 13 and 14 is used, in guiding the vehicle V stopped in the stop section PX to the parking section P, the guidance controller 7 of the parking facility control device 3 first controls the outside door portion 106 to be opened. Next, the guidance controller 7 transmits an entry permission signal to permit the vehicle V stopped in the stop section PX to enter the temporary standby section PY. Upon receiving the entry permission signal, the vehicle V stopped in the stop section PX self-travels to the temporary standby section PY indicated by the two section boundary lines L3 by the mounted camera 91. Upon the vehicle V arriving in the temporary standby section PY, the guidance controller 7 controls the outside door portion 106 to be closed. Next, the guidance controller 7 controls the inside door portion 19 to be opened.

Next, the guidance controller 7 transmits an entry permission signal to permit the vehicle V stopped in the temporary standby section PY to enter the parking section P. Upon receiving the entry permission signal, the vehicle V stopped in the temporary standby section PY self-travels to the parking section P indicated by the two section boundary lines L1 by the mounted camera 91. Upon the vehicle V arriving in the parking section P, the guidance controller 7 controls the inside door portion 19 to be closed. In this manner, the guidance controller 7 performs control such that at least one of the door portion 19 and the door portion 106 is closed while the vehicle V is guided from the stop section PX to the parking section P. Likewise, the guidance controller 7 performs control such that at least one of the door portion 19 and the door portion 106 is closed while the vehicle V is guided from the parking section P to the stop section PX. As a result, it is possible to suppress all of the inside of the accommodation portion 10 and the inside and the outside of the temporary accommodation portion 100 communicating with each other, and a situation in which the heat (warmed air) in the accommodation portion 10 is released to the outside through the opening portion 18 and the opening portion 105 can be suppressed more reliably.

In the parking facility 2A illustrated in FIGS. 13 and 14, the vehicle V may transmit an arrival signal to the parking facility control device 3 when the vehicle V has arrived in the temporary standby section PY or the parking section P, and the guidance controller 7 may control the door portion 19 or the door portion 106 to be opened and closed when the arrival signal has been received. Alternatively, the passage sensor 40 may be installed in one or both of the opening portion 18 and the opening portion 105, and the guidance controller 7 may control the door portion 19 or the door portion 106 to be opened and closed in accordance with a detection result from the passage sensor 40.

### Other Modification Examples

The present disclosure is not limited to the examples described above, and various other modifications are possible. For example, the opening portion 18 of the accommodation portion 10 may be provided with an air curtain. In this case, control is performed such that air flows in the vertical direction or the direction D2 in the opening portion 18 of the accommodation portion 10. Likewise, the opening portion 105 of the temporary accommodation portion 100 may be provided with an air curtain. With such a configuration, it is possible to suppress a situation in which the warmed air in the accommodation portion 10 flows out of the accommodation portion 10 while the door portion 19 and the door portion 106 are open.

The accommodation portion 10 does not have to include one opening portion 18 and one door portion 19. The accommodation portion 10 may include two or more opening portions and two or more door portions. For example, another opening portion may be formed in the side wall 15, which is on the side opposite to the side wall 14 where the opening portion 18 is formed, and another door portion may be installed in the other opening portion. In this case, the opening portion 18 of the side wall 14 may be used as the entrance of the accommodation portion 10 for the vehicle V to enter the accommodation portion 10 and the opening portion of the side wall 15 may be used as the exit of the accommodation portion 10 for the vehicle V to exit the accommodation portion 10.

The accommodation portion 10 may include a passageway for a person to enter and exit. In this case, in a case where a decline in the thermal insulation of the accommodation portion 10 attributable to air outflow from the passageway is acceptable, the driver may be able to exit the passageway after the vehicle V enters the accommodation portion 10 by being manually driven by the driver and stops in the parking section P of the accommodation portion 10. In a case where the vehicle V is moved by manual driving in this manner, the opening and closing operation of the door portion 19 provided in the accommodation portion 10 or the like may be performed by the driver's instruction (for example, remote control operation). Then, when the vehicle V has arrived in the parking section P, the driver may notify the parking facility control device 3 of the parking section P where the vehicle V has arrived and the ID of the vehicle V by wireless communication. When power feeding to the vehicle V is performed, the power feeding device 20 may be a wired power feeding device supplying electric power to the vehicle V using a cable or the driver may use a cable to perform manual and wired connection between the power feeding device 20 and the vehicle V.

In the case of wired connection by cable between the power feeding device 20 and the vehicle V, the power feeding device 20 and the vehicle V may be automatically connected by the cable. In this case, the vehicle V includes, for example, a socket installed on the bottom surface of the vehicle V instead of the power receiving coil unit 71. Further, the power feeding device 20 includes a plug capable of ascending and descending in the vertical direction instead of the power transmission coil unit 21. In this configuration, when the vehicle V has arrived in the parking section P, the plug is inserted into the socket of the vehicle V by raising the plug of the power feeding device 20. As a result, the plug of the power feeding device 20 is automatically connected to the socket of the vehicle V, and wired power feeding is performed from the power feeding device 20 to the vehicle V.

In a case where power is wirelessly supplied from the power feeding device 20 to the vehicle V, the power receiving coil unit 71 of the vehicle V does not necessarily have to be provided on the lower surface of the vehicle V and may be provided on, for example, a side surface of the vehicle V. In this case, the power transmission coil unit 21 of the power feeding device 20 may be installed above the floor surface 11 of the parking section P, and the power receiving coil unit 71 provided on the side surface of the vehicle V may face the power transmission coil unit 21 in the horizontal direction when the vehicle V has stopped in the parking section P.

The accommodation portion 10 may be configured to include a high-thermal insulation material (for example, double glazing or transparent heat insulting sheet) that is capable of transmitting light in a wavelength band detectable by the camera 91 of the vehicle V (for example, visible light or near-infrared light). In this case, the two section boundary lines L1 can be recognized from the vehicle V positioned outside the accommodation portion 10 even with the door portion 19 closed. Likewise, the temporary accommodation portion 100 may be configured to include the material described above. In this case, the two section boundary lines L3 can be recognized from the vehicle V positioned outside the temporary accommodation portion 100 even with the door portion 106 closed.

The accommodation portion 10 may be configured to include, for example, a material with an electrical shield function (for example, ferrite). In this case, it is possible to reduce propagation of electromagnetic waves generated during power feeding to the vehicle V to the outside of the accommodation portion 10. Likewise, the temporary accommodation portion 100 may configured to include the material described above.

In the accommodation portion 10, a fan may be provided at a position close to the ceiling wall 13. In this case, by operating the fan, the air warmed in the parking section P where power feeding to the vehicle V is performed can be forced to flow to the parking section P where power feeding to the vehicle V is not performed. As a result, the temperature inside the accommodation portion 10 can be made uniform.

In the embodiment described above, the vehicle V recognizes the region sandwiched between the two section boundary lines L1 illuminated by the light 30 that is turned on as the parking section P and self-travels. However, the self-driving method of the vehicle V and how to designate an area where the vehicle V is to stop are not particularly limited insofar as the vehicle V is capable of self-traveling to and stopping at a predetermined position. For example, a light may be provided on each section boundary line L1. In this case, control may be performed such that only two section boundary lines L1 are turned on and the other section boundary lines L1 are turned off when the vehicle V is guided to the parking section P.

In the embodiment described above, when power feeding to the vehicle V is performed, the guidance controller 7 may control the door portion 19 to be opened in a case where the charging rate of the battery 73 is not higher than a predetermined threshold and the temperature detected by the temperature sensor 60 is higher than the upper limit of a predetermined temperature range. In this case, the temperature inside the accommodation portion 10 can be lowered by the opening portion 18 of the accommodation portion 10 being opened, and thus it is possible to resume power feeding to the vehicle V and increase the charging rate of the battery 73.

Exemplified in the embodiment described above is a case where the power feeding controller 8 performs control so as to switch between stopping and starting power feeding to the vehicle V in accordance with the temperature detected by the temperature sensor 60. However, the power feeding controller 8 may perform control so as to increase or decrease the amount of electric power supply from the power feeding device 20 to the vehicle V in accordance with the temperature detected by the temperature sensor 60. For example, the power feeding controller 8 may perform control so as to increase the amount of electric power supply from the power feeding device 20 to the vehicle V in the case of a large temperature difference between the temperature detected by the temperature sensor 60 and the temperature range suitable for keeping the battery 73 warm. The power feeding controller 8 may perform control so as to decrease the amount of electric power supply from the power feeding device 20 to the vehicle V in a case where the temperature difference is small. For example, in a case where the price of electricity fluctuates depending on the electric power demand, it may be possible to suppress an increase in electricity payment by adjusting the amount of electric power supply from the power feeding device 20 to the vehicle V in accordance with the temperature difference as described above.

In the embodiment described above, in a case where the time at which the vehicle V is to exit the parking facility 2 is known in advance, the power feeding controller 8 may perform control such that the vehicle V that exits early is first fed with power (or is fed with high electric power) and may perform control such that the vehicle V that exits later is delayed in power feeding start (or is fed with low electric power). As a result, it is possible to reduce the possibility that the vehicle V exiting early exits undercharged.

### APPENDIX

The power feeding system of the present disclosure is capable of contributing to the popularization of electric cars and thus contributes to Goal 13: “Climate Action” of the United Nations-led Sustainable Development Goals (SDGs).

What is claimed is:

1. A power feeding system feeding power to a vehicle equipped with a battery, the power feeding system comprising:
an accommodation portion including a heat insulating material and configured to accommodate the vehicle;
a power feeding unit configured to feed power to the battery of the vehicle accommodated in the accommodation portion;
a power feeding controller configured to control the power feeding to the battery by the power feeding unit; and
a temperature sensor configured to detect temperature inside the accommodation portion,
wherein the power feeding controller is configured to control the power feeding to the battery such that the temperature detected by the temperature sensor is within a temperature range suitable for keeping the battery warm.

2. The power feeding system according to claim 1, wherein the power feeding controller is configured to instruct the power feeding unit to stop the power feeding to the battery in a case where the temperature detected by the temperature sensor is higher than an upper limit of the temperature range.

3. The power feeding system according to claim 1, wherein the power feeding controller is configured to instruct the power feeding unit to start the power feeding to the battery in a case where the temperature detected by the temperature sensor is lower than a lower limit of the temperature range.

4. The power feeding system according to claim 1, wherein the power feeding controller is configured to output a signal instructing discharge of the battery to be started in a case where the temperature detected by the temperature sensor is lower than a lower limit of the temperature range and a charging rate of the battery is higher than a predetermined threshold.

5. The power feeding system according to claim 1, wherein the temperature sensor is installed at a position in the accommodation portion closer to a ceiling wall of the accommodation portion than to a floor surface of the accommodation portion.

6. The power feeding system according to claim 1, wherein the power feeding unit includes a coil unit installed on a floor surface of the accommodation portion and configured to wirelessly transmit power to the battery.

7. The power feeding system according to claim 6, wherein the coil unit is exposed in the accommodation portion from the floor surface.

8. The power feeding system according to claim 6, wherein
the power feeding unit further includes a power transmission circuit unit electrically connected to the coil unit and configured to transmit power to the coil unit, and
the power transmission circuit unit is installed at a position in the accommodation portion closer to the floor surface than to a ceiling wall of the accommodation portion.

9. The power feeding system according to claim 1, comprising a first power feeding unit as the power feeding unit and a second power feeding unit as the power feeding unit,
wherein the first power feeding unit and the second power feeding unit are installed so as to be separated in a direction along a floor surface of the accommodation portion.

10. The power feeding system according to claim 9, wherein the temperature sensor is positioned between the first power feeding unit and the second power feeding unit in the direction along the floor surface of the accommodation portion.

11. The power feeding system according to claim 1, further comprising a guidance controller configured to guide the vehicle into the accommodation portion, wherein
the accommodation portion is provided with an opening portion configured for the vehicle to be capable of passing through the opening portion, a door portion configured to be capable of opening and closing the opening portion, and a passage sensor configured to detect whether or not the vehicle has passed through the opening portion, and
the guidance controller is configured to control the door portion to be opened when the vehicle enters the accommodation portion from the opening portion and control the door portion to be closed when the passage sensor has detected that the vehicle has passed through the opening portion.
